(19) United States
(12) Patent Application Publication
(10) Pub. No.: US 2025/0135728 A1
(43) Pub. Date: May 1, 2025

(54) SYSTEMS, DEVICES, AND METHODS FOR WELDING

(71) Applicant: CHAWK TECHNOLOGY INTL., INC., Hayward, CA (US)

(72) Inventors: Jonathan J. CHANG, Mountain House, CA (US); Alexander E. KRUKOV, Hayward, CA (US); Perinkulam S. KASTHURI, Hayward, CA (US)

(21) Appl. No.: 19/008,250

(22) Filed: Jan. 2, 2025

Related U.S. Application Data
(63) Continuation of application No. PCT/US2023/069766, filed on Jul. 7, 2023.
(60) Provisional application No. 63/359,531, filed on Jul. 8, 2022.

(51) Int. Cl. B29C 65/12; B29C 65/00

(52) U.S. Cl. CPC B29C 65/12; B29C 66/87

(57) ABSTRACT

Described here are systems, devices, and methods useful for welding. Generally, a welding system may comprise a feeder configured to receive a welding rod, a heater coupled to the feeder, the heater configured to control a temperature of the welding rod, and a cutter coupled to the feeder, the cutter configured to cut the welding rod disposed within the feeder.

### CROSS-REFERENCE TO RELATED APPLICATIONS

The present application is a continuation of International PCT Application No. PCT/US2023/069766, filed Jul. 7, 2023, which claims the benefit of U.S. Provisional Application No. 63/359,531, filed Jul. 8, 2022, the content of which is hereby incorporated by reference in its entirety.

### TECHNICAL FIELD

Devices, systems, and methods herein relate to welding, including but not limited to thermal polymer welding.

### BACKGROUND

Consumer demand for welded products fabricated with high quality, consistency, and speed continues to grow. However, conventional polymer welding techniques require tradeoffs with respect to one or more of scale, speed, cost, precision, consistency, flexibility, dexterity, impermeability, and application. For example, manual welding facilitates precise welds with complex geometry in tight spaces but commonly suffer in aesthetics, welding strength, and consistency. Furthermore, manual welding is difficult to scale and is limited by the size of the available labor pool. Semi-automated solutions are bulky such that they are limited in applications to external weldments with simple geometry. Accordingly, it is desirable to provide an improved welding system.

### SUMMARY

Described here are systems, devices, and methods useful for welding. In some variations, the procedures described herein may generate a set of polymer welds (e.g., hot gas welds) using a robotic welding system. Generally, a welding system may comprise a feeder configured to receive and drive a welding rod, a heater coupled to the feeder, the heater configured to control a temperature of the welding rod to be welded, and a cutter coupled to the feeder, the cutter configured to cut the welding rod disposed within the feeder to precisely perform a welding operation (e.g., form a set of distinct welds) absent human intervention.

In some variations, the feeder may comprise a first elongate body defining a first lumen and a first outlet. In some variations, the first elongate body may comprise a first portion and a second portion distal to the first portion. The first portion may define a first longitudinal axis and the second portion may be non-parallel to the first longitudinal axis of the first elongate body. In some variations, the second portion may be angled up to about 30 degrees relative to the first longitudinal axis of the first elongate body. In some variations, the second portion may be angled between about 30 degrees and about 60 degrees relative to the first longitudinal axis of the first elongate body. In some variations, the first portion may be proximal to the second portion, and the first portion may comprise a first length and the second portion may comprise a second length shorter than the first length.

In some variations, the first portion may comprise a sidewall defining an aperture configured to receive the cutter. In some variations, the feeder may comprise a die configured to modify a diameter of the welding rod. In some variations, the feeder may comprise a set of rollers coupled to an actuator, the set of rollers configured to advance the welding rod through the feeder. In some variations, the feeder may comprise a gear drive coupled between the set of rollers and the actuator. In some of these variations, the feeder may comprise a reel coupled to an actuator, the welding rod wound around the reel. In some variations, the feeder may be configured to feed the welding rod to a substrate at a predetermined rate based on one or more weld parameters. In some variations, the predetermined rate may comprise a speed of between about 0.5 mm/sec and about 20 mm/sec.

In some variations, the cutter may be configured to cut the welding rod between a proximal end and a distal end of the feeder. In some variations, the cutter may be configured to cut an unheated portion of the welding rod disposed within the first elongate body. In some variations, the cutter may be configured to cut an unheated portion of the welding rod through the aperture. In some variations, the cutter may be configured to cut the welding rod based on a weld parameter. In some variations, the weld parameter may comprise one or more of length, geometry, material, and temperature. In some variations, the welding system may further comprise a memory, and a processor operatively coupled to the memory and the position sensor. The processor may be configured to receive the position signal and a set of weld parameters, and cut the welding rod using the cutter based on the position signal and the set of weld parameters.

In some variations, the first outlet may comprise a beveled edge facing the heater. In some variations, the beveled edge may be angled up to about 75 degrees relative to a distal end of the first outlet. In some variations, the first outlet may define an aperture at a distal end of the first elongate body and along a sidewall of the first elongate body facing the heater. In some variations, the feeder may comprise a position sensor configured to generate a position signal corresponding a position of the welding rod. In some variations, a position sensor may be configured to generate a welding rod signal corresponding to a presence of the welding rod disposed in the first elongate body. In some variations, the first elongate body may comprise a proximal body defining a first longitudinal axis and a distal body defining a second longitudinal axis and an angle of about 15 degrees between the first and second longitudinal axis.

In some variations, the welding system may further include a memory, and a processor operatively coupled to the memory and the position sensor. The processor may be configured to receive the welding rod signal and a set of weld parameters, and determine a welding rod feed rate based on the welding rod signal and the set of weld parameters.

In some variations, the cutter may be configured to cut the welding rod between a proximal end and the distal end of the feeder. In some variations, the cutter may be distal to the set of rollers. In some variations, the cutter may be configured to cut an unheated portion of the welding rod disposed within the first elongate body. In some variations, the cutter may be non-parallel to the first longitudinal axis. In some variations, the cutter may be angled up to about 60 degrees relative to the first longitudinal axis. In some variations, the cutter may be configured to cut an unheated portion of the welding rod through the aperture. In some variations, the cutter may comprise one or more blades. In some variations, the cutter may be configured to cut the welding rod based on a weld parameter. In some variations, the weld parameter may comprise one or more of length, geometry, material, and temperature. In some variations, the welding system may include a memory, and a processor operatively coupled to the memory and the position sensor. The processor may be configured to receive the position signal and a set of weld parameters, and cut the welding rod using the cutter based on the position signal and the set of weld parameters.

In some variations, the heater may comprise a gas source, a second elongate body, and a heating element, the heater configured to output heated gas at a predetermined flow rate. In some variations, the heating element may be distal to the cutter. In some variations, the second elongate body defines a second lumen and a second outlet. In some variations, the second elongate body comprises a bend configured to deliver a hot gas to the first outlet of the feeder. In some variations, the feeder defines a first longitudinal axis and the heater defines a second longitudinal axis. An angle between the first longitudinal axis and the second longitudinal axis may be less than about 15 degrees. In some variations, the second elongate body may comprise a sidewall defining a third outlet facing the feeder. In some variations, the third outlet may be configured to heat the welding rod at a first predetermined temperature and the second outlet is configured to melt the welding rod at a second predetermined temperature. In some variations, the heating element may be disposed within the second lumen of the second elongate body. In some variations, the heating element may be made of one or more of ceramic and quartz. In some variations, the gas source may comprise compressed air. In some variations, the heater may comprise one or more temperature sensors configured to generate a temperature signal corresponding to a temperature of one or more of the second elongate body, the welding rod, and a substrate. In some variations, the welding system may further comprise a memory, and a processor operatively coupled to the memory and the one or more temperature sensors. The processor may be configured to receive the temperature signal and a set of weld parameters, and select one or more parameters of the gas source and heating element based on the temperature signal and the set of weld parameters. In some variations, one or more temperature sensors may comprise one or more of a thermocouple, infrared sensor, and laser sensor.

In some variations, the heating element may be parallel to the cutter. In some variations, the second outlet may be proximal to the first outlet. In some variations, the first outlet and the second outlet may be non-parallel. In some variations, the first outlet may be angled up to about 45 degrees relative to the second outlet. In some variations, the second elongate body may comprise a third portion and a fourth portion distal to the third portion. The third portion may define a second longitudinal axis and the fourth portion may be non-parallel to the second longitudinal axis of the second elongate body. In some variations, the fourth portion may be angled up to about 30 degrees relative to the second longitudinal axis of the second elongate body. In some variations, the fourth portion may be angled between about 30 degrees and about 60 degrees relative to the second longitudinal axis of the second elongate body. In some variations, one or more of the heating element and the second elongate body may comprise thermal insulation. In some variations, the third outlet may be configured to heat the welding rod at a first predetermined temperature and the second outlet may be configured to melt the welding rod at a second predetermined temperature. In some variations, the heating element may be coupled to the second lumen of the second elongate body. In some variations, the second outlet may be positioned within about 2 cm of the first outlet. In some variations, the heating element may comprise one or more of ceramic and quartz. In some variations, the gas source may comprise pressurized gas.

In some variations, the heater may comprise one or more temperature sensors configured to generate a temperature signal corresponding to a temperature of one or more of the second elongate body, the welding rod, and a substrate. In some variations, one or more temperature sensors may comprise one or more of a thermocouple, infrared sensor, and laser sensor. In some variations, the welding system may include a memory, and a processor operatively coupled to the memory and the one or more temperature sensors. The processor may be configured to receive the temperature signal and a set of weld parameters, and select one or more parameters of the gas source and heating element based on the temperature signal and the set of weld parameters.

In some variations, the heater may define a plurality of second outlets arranged radially about the first outlet of the feeder. In some variations, the feeder may comprise a distal portion including the first outlet, and may further comprise a cooling element configured to control a temperature of the distal portion. The cooling element may define a third lumen. The distal portion may be disposed in the third lumen. In some variations, the cooling element may be configured to circulate a non-heated fluid through the third lumen to cool the distal portion. In some variations, the cooling element may define a third outlet configured to output the non-heated fluid. In some variations, the cooling element may comprise a pump configured to circulate the non-heated fluid. In some variations, the non-heated fluid may comprise air.

In some variations, the heater may comprise a manifold fluidically coupled between the second elongate body and the plurality of second outlets. In some variations, the manifold may be arranged circumferentially around the third lumen of the cooling element. In some variations, the heater may comprise one or more valves configured to control a flow rate of the heated gas through each of the plurality of second outlets.

In some variations, an end effector connector may be coupled to one or more of the feeder, heater, and the cutter. In some variations, a robotic arm may be coupled to the end effector connector. In some variations, a joint may be coupled to the end effector connector and one or more of the feeder, the heater, and the cutter. The joint may be configured to rotate the feeder, the heater, and the cutter relative to the end effector connector.

In some variations, the joint may be configured to rotate up to about 90 degrees relative to the end effector connector. In some variations, the joint may be disposed between the end effector connector and one or more of the feeder, the heater, and the cutter. In some variations, the joint may comprise a gear and a motor configured to drive the gear. In some variations, the welding system may include a memory, a processor operatively coupled to the memory and the joint. The processor may be configured to receive a set of weld parameters comprising an attack angle, rotate the joint based on the attack angle.

In some variations, the welding system may include an enclosure comprising a hermetic seal. The enclosure may be configured to enclose a platform configured to receive a substrate for welding, a feeder configured to receive a welding rod, a heater configured to control a temperature of the welding rod, a cutter configured to cut the welding rod, and a robotic arm coupled to the feeder, the heater and the cutter. A vacuum source may be coupled to the enclosure. The vacuum source may be configured to apply negative pressure to the enclosure. In some variations, the welding system may include a filter configured to remove one or more impurities removed from the enclosure. In some variations, an exterior of the enclosure may comprise an input device configured to receive one or more commands from an operator. In some variations, an interior of the enclosure may comprise an illumination source and one or more optical sensors configured to generate an image signal corresponding to a set of welds. In some variations, an exterior of the enclosure may comprise an output device configured to output the image signal. In some variations, the enclosure may be configured to hermetically seal the platform, the feeder, the heater, the cutter, and the robotic arm. In some variations, the enclosure may comprise one or more entrances. In some variations, one or more conduits may fluidically couple the enclosure and the vacuum source.

In some variations, the welding system may include an optical sensor configured to generate an image signal corresponding to a set of welds, a memory, and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics. In some variations, the predicted set of characteristics may comprise one or more of size, shape, geometry, and color. In some variations, the welding rod may comprise a thermoplastic and the substrate comprises a polymer.

In some variations, an end effector connector may be coupled to each of the feeder, heater, and the cutter. A robotic arm may be coupled to the end effector connector. In some variations, the end effector connector may comprise a joint configured to approach an attack angle. In some variations, a platform may be configured to receive a substrate for welding. In some variations, the platform may be configured to rotate or pivot the substrate relative to the feeder. In some variations, the robotic arm may comprise one or more segments coupled by one or more joints configured to provide a single degree of freedom. In some variations, the robotic arm may comprise one or more motors configured to translate and/or rotate the one or more joints. In some variations, the robotic arm may comprise six or more degrees of freedom. In some variations, the robotic arm may comprise less than six degrees of freedom. In some variations, the robotic arm may comprise one or more of an articulated robotic arm, a Selective Compliance Articulated Robot Arm (SCARA) robotic arm, and a linear robotic arm. In some variations, the robotic arm may be mounted to a base comprising one or more of a wall, a ceiling, a ground, a cart, a turntable, hydraulic lift, pneumatic lift, and a platform. In some variations, the base may be configured to move the robotic arm along at least a first axis. In some variations, a molder may be coupled to one or more of the feeder, the heater, the cutter, and the robotic arm, the molder configured to shape a weld formed on a substrate.

In some variations, an optical sensor may be configured to generate an image signal corresponding to a set of welds. The welding system may further comprise a memory and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics. In some variations, the predicted set of characteristics may comprise one or more of size, shape, geometry, and color. In some variations, the welding rod comprises a thermoplastic and the substrate comprises a polymer.

Also described herein are welding systems including a feeder defining a first lumen and a first outlet. The feeder may be configured to advance a welding rod through the first lumen and the first outlet. A heater may be coupled to the feeder. The heater may define a second lumen and a plurality of second outlets arranged radially about the first outlet of the feeder. The heater may be configured to output a heated gas to heat the welding rod.

In some variations, the feeder may comprise a distal portion including the first outlet. A cooling element may be configured to control a temperature of the distal portion. The cooling element may define a third lumen. The distal portion may be disposed in the third lumen.

In some variations, the cooling element may be configured to circulate a non-heated fluid through the third lumen to cool the distal portion. In some variations, the cooling element may define a third outlet configured to output the non-heated fluid. In some variations, the cooling element may comprise a pump configured to circulate the non-heated fluid. In some variations, the non-heated fluid may comprise air. In some variations, the heater may comprise a manifold fluidically coupled between the second elongate body and the plurality of second outlets. In some variations, the manifold may be arranged circumferentially around the third lumen of the cooling element. In some variations, the heater may comprise one or more valves configured to control a flow rate of the heated gas through each of the plurality of second outlets.

Also described herein are welding systems comprising an enclosure comprising a hermetic seal. The enclosure may comprise a platform configured to receive a substrate, a robotic arm coupled to the platform, a welding device coupled to the robotic arm, the welding device configured to form a set of welds on the substrate, and a vacuum source coupled to the enclosure, the vacuum source configured to apply negative pressure to the enclosure.

In some variations, the welding device may comprise a feeder configured to receive a welding rod, and a heater coupled to the feeder. The heater may be configured to control a temperature of the welding rod. A cutter may be coupled to the feeder. The cutter may be configured to cut the welding rod disposed within the feeder. In some variations, a filter may be configured to remove one or more impurities removed from the enclosure.

In some variations, an exterior of the enclosure may comprise an input device configured to receive one or more commands from an operator. In some variations, an interior of the enclosure may comprise an illumination source and one or more optical sensors configured to generate an image signal corresponding to the set of welds. In some variations, an exterior of the enclosure may comprise an output device configured to output the image signal. In some variations, the enclosure may comprise one or more entrances. In some variations, one or more conduits may fluidically couple the enclosure and the vacuum source.

Also described here is a welding grading system comprising an optical sensor configured to generate an image signal corresponding to a set of welds, a memory, and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics.

In some variations, the machine learning model may comprise one or more of a deep learning model, convolutional neural network (CNN), and combinations thereof. In some variations, the predicted set of characteristics may comprise one or more of size, shape, geometry, and color. In some variations, grading the set of welds may be based on a set of predetermined criteria.

Also described here is a method of welding including the steps of receiving a substrate on a platform. The platform may be coupled to a robotic arm, the robotic arm coupled to a welding device, the welding device comprising a feeder, a heater, and a cutter. The method further includes the steps of positioning the welding device relative to the substrate using the robotic arm, advancing a welding rod through the feeder towards the substrate, heating the welding rod at a distal end of the feeder using the heater, outputting the heated welding rod on the substrate to form a weld, and cutting the welding rod disposed within the feeder using a cutter.

In some variations, a position signal corresponding a position of the welding rod may be generated. In some variations, the welding rod may be cut using the cutter based on the position signal and a set of weld parameters. In some variations, a temperature signal corresponding to a temperature of one or more of the second elongate body, the welding rod, and a substrate may be generated. In some variations, one or more parameters of the gas source and a heating element of the heater may be selected based on the temperature signal and a set of weld parameters. In some variations, one or more parameters of the gas source may comprise a flow rate. In some variations, an attack angle is selected based on the geometry of the substrate and a joint is adjusted to approach the attack angle.

In some variations, positioning the welding device relative to the substrate may be based on a set of weld parameters including an attack angle corresponding to a geometry of the substrate. In some variations, the substrate, the platform, the robotic arm, and the welding device may be hermetically sealed using an enclosure, and negative pressure may be applied to the enclosure. In some variations, the enclosure may transition from an open configuration to a closed configuration using one or more entrances. In some variations, one or more impurities may be filtered from the enclosure. In some variations, a presence of the welding rod disposed in the feeder may be determined. In some variations, a welding rod feed rate may be determined based on the determined presence of the welding rod and a set of weld parameters. In some variations, the welding rod may be cut between a proximal end and the distal end of the feeder. In some variations, an unheated portion of the welding rod may be cut using the cutter.

In some variations, a temperature of one or more of the feeder, the welding rod, and the substrate may be measured, and one or more parameters of the heater may be selected based on the measured temperature and a set of weld parameters. In some variations, one or more parameters of the heater may comprise a flow rate. In some variations, a distal portion of the feeder may be cooled using a cooling element. In some variations, cooling the distal portion of the feeder may comprise circulating a non-heated fluid through the cooling element using a pump. In some variations, heating the welding rod at a distal end of the feeder may comprise outputting a heated gas from the heater and adjusting a flow rate of the heated gas using one or more valves. In some variations, heating the welding rod may comprise outputting the heated gas from a plurality of outlets of the heater and independently adjusting the flow rate of the heated gas from the plurality of outlets.

In some variations, an interior of the enclosure may be illuminated. An image signal corresponding to the weld may be generated. In some variations, the image signal may be output using a display coupled to an exterior of the enclosure. In some variations, an image signal corresponding to a set of welds may be generated using an optical sensor. In some variations, a set of characteristics of the set of welds may be predicted based on the image signal. In some variations, the set of welds may be graded based on the predicted set of characteristics.

Also described here is a method of grading a weld comprising, at one or more processors, receiving an image signal corresponding to a set of welds and generated by an optical sensor, predicting a set of characteristics of the set of welds based on the image signal using a machine learning model, grading the set of welds based on the predicted set of characteristics.

In some variations, the machine learning model may comprise one or more of a deep learning model, a convolutional neural network, and combinations thereof. In some variations, the predicted set of characteristics may comprise one or more of size, shape, geometry, and color. In some variations, grading the set of welds may be based on a set of predetermined criteria.

### BRIEF DESCRIPTION OF THE DRAWINGS

FIG. 1 is a block diagram of an illustrative variation of a welding system.

FIG. 2A depicts a perspective view of an illustrative variation of a welding system. FIG. 2B depicts a top view of an illustrative variation of a welding system. FIG. 2C depicts a front view of an illustrative variation of a welding system. FIG. 2D depicts a left side view of an illustrative variation of a welding system. FIG. 2E depicts a right side view of an illustrative variation of a welding system. FIG. 2F depicts a top view of an illustrative variation of a welding system relative to a substrate.

FIGS. 3A and 3B depict perspective views of an illustrative variation of a feeder of a welding system. FIG. 3C depicts a side view of an illustrative variation of a feeder of a welding system. FIG. 3D depicts a front view of an illustrative variation of a feeder of a welding system. FIG. 3E is another side view of an illustrative variation of a feeder of a welding system.

FIG. 4A depicts a side view of an illustrative variation of a heater of a welding system. FIG. 4B depicts a detailed perspective view of an illustrative variation of a heater of a welding system.

FIGS. 5A and 5D depict top views of an illustrative variation of a cutter and feeder of a welding system. FIGS. 5B and 5C depict perspective views of an illustrative variation of a cutter and feeder of a welding system. FIG. 5E depicts a side view of an illustrative variation of a cutter and feeder of a welding system.

FIG. 6 depicts a flowchart representation of an illustrative variation of a method of welding a substrate.

FIG. 7 depicts a flowchart representation of an illustrative variation of a method of grading a weld.

FIGS. 8A and 8B depict perspective views of an illustrative variation of a welding system. FIGS. 8C and 8D depict perspective views of an illustrative variation of welding system. FIG. 8E depicts a top view of an illustrative variation of a welding system. FIG. 8F depicts a bottom view of an illustrative variation of welding system. FIG. 8G depicts a left side view of an illustrative variation of a welding system. FIG. 8H depicts a right side view of an illustrative variation of a welding system. FIG. 8I depicts a front view of an illustrative variation of a welding system. FIG. 8J depicts a top view of an illustrative variation of a welding system. FIG. 8K depicts a bottom view of an illustrative variation of a welding system.

FIG. 9A depicts a perspective view of an illustrative variation of a feeder of a welding system. FIG. 9B depicts a front view of an illustrative variation of a feeder of a welding system. FIG. 9C depicts a left side view of an illustrative variation of a feeder of a welding system. FIG. 9D depicts a right side view of an illustrative variation of a feeder of a welding system.

FIG. 10A depicts a bottom view of an illustrative variation of a first elongate body and a cutter of a welding system. FIG. 10B depicts a left side view of an illustrative variation of a first elongate body and a cutter of a welding system. FIG. 10C depicts a right side view of an illustrative variation of a first elongate body and a cutter of a welding system. FIG. 10D depicts a perspective view of an illustrative variation of a first elongate body and a cutter of a welding system. FIG. 10E depicts a detailed bottom view of an illustrative variation of a portion of a first elongate body and a cutter of a welding system. FIG. 10F depicts a detailed perspective view of an illustrative variation of a portion of a first elongate body and a cutter of a welding system.

FIG. 11A depicts a perspective view of an illustrative variation of a heater of a welding system. FIG. 11B depicts a front view of an illustrative variation of a heater of a welding system. FIG. 11C depicts a detailed bottom view of an illustrative variation of an outlet of a heater.

FIG. 12A depicts a front view of an illustrative variation of a heater outlet and a feeder outlet of a welding system. FIG. 12B depicts a left side view of an illustrative variation of a heater outlet and a feeder outlet of a welding system.

FIG. 13A depicts a perspective view of an illustrative variation of a distal end of a welding system. FIG. 13B depicts a front view of an illustrative variation of a distal end of a welding system. FIG. 13C depicts a side cross-sectional view of an illustrative variation of a distal end of a welding system.

FIG. 14A depicts a perspective view of an illustrative variation of a welding system with an enclosure in a closed configuration. FIG. 14B depicts a perspective view of an illustrative variation of a welding system with an enclosure in an open configuration. FIG. 14C depicts a perspective view of an illustrative variation of a welding system.

FIG. 15A depicts a perspective view of an illustrative variation of a welding system including a joint. FIG. 15B depicts a detailed perspective view of an illustrative variation of a joint and an end effector connector. FIG. 15C depicts a top view of an illustrative variation of a joint and an end effector connector.

### DETAILED DESCRIPTION

Described here are systems, devices, and methods for use in welding. For example, the systems, devices, and methods described herein may improve polymer (e.g., thermoplastic, hot gas) welding by one or more of: operating and/or managing a robotic welding system with a minimum number of operators for a plurality of weld geometries; increasing weldment quality (e.g., strength, hermetic seal), cosmetic appearance (e.g., reduced rivelling), consistency, scalability, and efficiency relative to human welders; providing closed-loop temperature control of a weld; facilitating and rapid tool (e.g., welding head, end effector) exchanges; facilitating visualization, tracking, and identification during a welding procedure; grading weld quality in real-time; minimizing welding constraints such as substrate geometry based on welding device geometry and adjustability; and increasing air quality thereby reducing environmental impact and improving operator safety. One or more of these benefits may help meet the increasing demand for high quality welded assemblies and may assist in addressing the lack of skilled welders.

The systems, devices, and methods for use in welding described herein may improve the welding process as compared to manual welding. Manual welding (e.g., hot gas welding) requires skilled labor to form weldments. The need for skilled labor and other characteristics of manual welding makes manual welding undesirable for industrial welding applications. For example, manual welding lacks scalability due to its reliance on a narrow skilled labor pool; lacks repeatability due to human variance; requires additional resources (e.g., equipment, training) to protect workers from hazardous materials and/or hazardous byproducts of a welding process (e.g., toxic gases, high temperatures); lacks desirable cosmetic appearance due to human variance; and can result in a lack of desired weldment quality (e.g., strength, hermetic seal).

The systems, devices, and methods described herein may automate one or more welding steps to thereby reduce the impact of, in some instances, remedy the deficiencies of manual welding and reduce the need for skilled labor or other operators. For example, closed-loop feedback control of the welding rod feed rate and welding temperature may improve the repeatability, cosmetic appearance, and weldment quality as compared to manual welding. Additionally or alternatively, systems, devices, and method of welding described herein may improve scalability and efficiency as compared to manual welding by reducing the reliance on skilled labor.

The systems, devices, and methods of welding described herein may provide improved performance and/or functionality relative to conventional welding systems. For example, some conventional welding methods suffer from limited weld sizes and welding footprints (e.g., ultrasonic, induction, friction, spin, laser, hot plate, infrared, butt). By contrast, the systems, devices, and methods of welding described herein may facilitate a wide range of weld sizes and welding footprints by, for example, providing additional degrees of freedom with a compact and interchangeable welding device (e.g., welding head).

Furthermore, conventional welding methods are limited to a small range of substrate geometries (e.g., straight lines, simple corners) and conventional welding techniques such as hot gas, extrusion, induction, friction, spin, laser, infrared, and butt welding techniques are not capable of forming welds where the substrate has a deep cavity (e.g., internal welds on tubular substrates with small radii or long sidewalls), a narrow pocket (e.g., internal sharp corners formed by two faces of the substrate meeting at a narrow angle), and/or a 360 degree weld due to one or more of large, bulky components and/or limitations on positioning, orientation, and/or movement. By contrast, the systems and device described herein may provide a range of welding geometries that meet and/or exceed welding geometries possible using manual welding systems. For example, the welding device described herein may include angled bends and an outlet of a feeder (e.g., nozzle) integrated with an outlet of a heater and a cooling element to facilitate challenging weld geometries such as internal sharp corners, deep cavities, narrow pockets, and the like.

Generally, a quality of a weld may be based on a number of weld parameters including the angle (e.g., attack angle) at which a substrate is approached by a welding device. In particular, an attack angle is the angle of a welding rod outlet relative to the substrate. For example, an attack angle of a weld formed on a flat substrate may be about 90 degrees, and an attack angle of a weld formed on a substrate having a right angle may be about 45 degrees. Conventional welding techniques may provide a limited range of attack angles due to the size of the welding device, substrate geometry, reach, access, and/or other characteristics. As described herein, one or more of a joint and bends in the welding system may facilitate a desired attack angle in a compact size for greater weld geometry flexibility relative to conventional welding systems.

In some variations, one or more of the feeder and heater may comprise one or more distal bends (e.g., angled portions), and the welding device may comprise a joint configured to rotate the feeder, the heater, and the cutter relative to a robotic arm to facilitate a full range of attack angles in a compact space (e.g., small volume). For example, a distal bend may be about 15 degrees, and the joint may be configured to rotate up to about 75 degrees to provide a 90 degree range of attack angles. In some variations, the cutter may be non-parallel to the feeder and configured to cut an unheated portion of the welding rod through an aperture of the feeder in order to minimize a size (e.g., volume) of the welding device. In some variations, a heater may be parallel and distal to the cutter.

Controlled (e.g., consistent, precise) heating of a weld, as opposed to uneven or unintended heating of a welding rod and/or a substrate, may increase one or more of weldment quality, cosmetic appearance, consistency, and efficiency. For example, premature heating of a welding rod in a lumen of a feeder may clog the feeder. Furthermore, uneven heating of a welding rod and/or substrate may be caused by directional heating, uncontrolled heating, or insufficiently controlled heating. Premature heating may be caused by heating elements disposed in close proximity to the welding rod. The systems and devices described herein may provide closed-loop welding rod temperature control to automatically adjust the flow of hot gas to heat a welding rod. Moreover, the heater may be disposed in close proximity to a feeder without generating undesirable heat that may lead to clogging or a melted substrate. Additionally or alternatively, a heater outlet may be configured to evenly distribute heat to the welding rod and/or substrate based on a set of weld parameters.

In some variations, the heater may include a plurality of outlets arranged radially about an outlet of the feeder and fluidically coupled by a manifold to independently control heating of a welding rod and/or substrate. A cooling element may be disposed around a distal portion of the feeder, which may assist in preventing clogging of the feeder.

Some thermal polymer welding materials and byproducts may be hazardous to operators and may introduce impurities (e.g., contaminants) that may decrease weldment quality. Manual welding of materials such as perfluoroalkoxy (PFA) requires operators to wear personal protective equipment to avoid exposure to toxic fumes. By contrast, the robotic welding systems described herein may include a hermetically sealable enclosure coupled to a pump and filter to control and remove hazardous chemicals and protect operators. For example, an enclosure may hermetically seal a welding device, a robotic arm, and a substrate to be welded. A vacuum source and a filter may be coupled to the enclosure such that the vacuum source applies negative pressure to the enclosure and the filter removes impurities from a welding process, thereby increasing operator and environmental safety.

Generally, a welding system may comprise a feeder configured to receive a welding rod, a heater coupled to the feeder, the heater configured to control a temperature of the welding rod, and a cutter coupled to the feeder, the cutter configured to cut the welding rod disposed within the feeder. A method of welding using the welding system may comprise providing a substrate, advancing a welding rod through a feeder towards the substrate, heating the welding rod at a distal end of the feeder using a heater, positioning the feeder and the heater relative to the substrate using a robotic arm, disposing the heated welding rod on the substrate to form a weld, and cutting the welding rod disposed within the feeder using a cutter.

In some variations, the welding rod may be cut using the cutter based on a position of the welding rod and a set of weld parameters. In some variations, the heater may be controlled based on a temperature of the weld and a set of weld parameters. The substrate to be welded is not particularly limited and may be useful in semiconductor, biomedical, aerospace applications, and the like. In some variations, the substrate may comprise a polymer such as a thermoplastic and/or a thermoset plastic. Additionally or alternatively, the substrate may comprise a composite material (e.g., material formed by combining two or more materials with different properties).

Also described here is a welding grading system comprising an optical sensor configured to generate an image signal corresponding to a set of welds, a memory, and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics.

### I. Systems and Devices

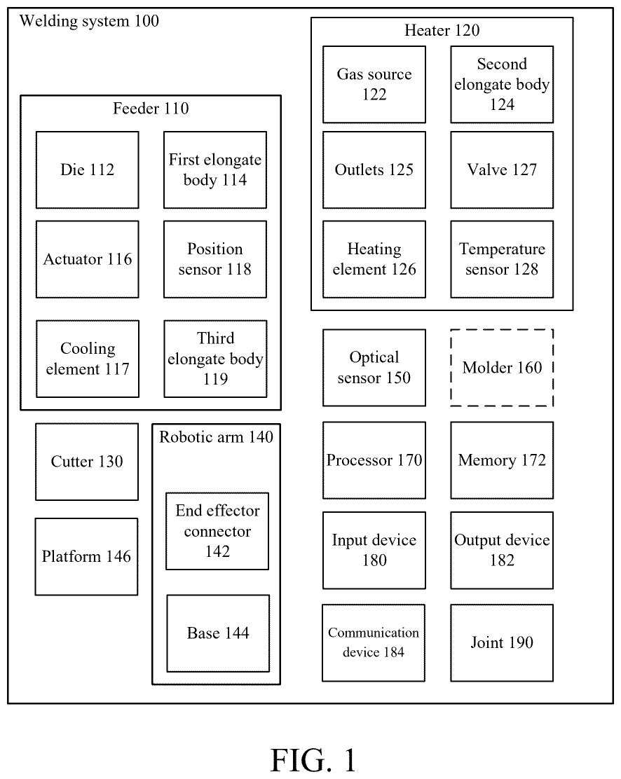

Generally, the welding systems described herein may be used to generate a set of polymer welds (e.g., thermoplastic) on a substrate (e.g., polymer). A block diagram of an exemplary welding system 100 is depicted in FIG. 1. The system 100 may comprise one or more of a feeder 110, a heater 120, a cutter 130, a robotic arm 140, a platform 146, an optical sensor 150, an optional molder 160, a processor 170, a memory 172, an input device 180, an output device 182, a communication device 184, and a joint 190 each of which are described in more detail herein.

In some variations, the feeder 110 may be configured to advance a welding rod towards a substrate (e.g., workpiece) for welding. The feeder 110 may comprise one or more of a die 112, a first elongate body 114, an actuator 116, a cooling element 117, a position sensor 118 (e.g., proximity sensor), and a third elongate body 119. The die 112 may be configured to receive and shape a welding rod to a predetermined diameter. For example, a set of welding rods may vary in diameter along their length which may impact the size and shape of the formed weld on a substrate. However, the die 112 may be configured to modify a diameter of the welding rod to ensure a consistent diameter of the welding rod advanced into the feeder 110. A consistent welding rod diameter may reduce jamming within the first elongate body 114 and enable consistent weldment. In some variations, the die 112 may be coupled to a proximal end of the first elongate body 114.

In some variations, the first elongate body 114 may define a first lumen, a first inlet, and a first outlet (e.g., first nozzle). In some variations, the first elongate body 114 comprises a sidewall defining an aperture configured to receive the cutter 130. In some variations, the actuator 116 may be configured to advance the welding rod through one or more of the die 112 and the first elongate body 114. For example, the actuator 116 may comprise one or more guides (e.g., rollers, tracks) and/or motors configured to advance the welding rod along a predetermined path and at a predetermined rate. In some variations, the actuator 116 may be coupled between the die 112 and the first elongate body 114. In this manner, the feeder 110 may be configured to feed the welding rod to a substrate to be welded at a predetermined rate based on one or more weld parameters (e.g., size, shape, geometry, material, temperature).

The cooling element 117 may be configured to control a temperature of a welding rod within a distal portion of the first elongate body 114. For example, premature heating of a welding rod disposed within the first elongate body 114 may melt the welding rod such that the feeder 110 clogs. In some variation, the cooling element 117 may define a third lumen where the distal portion of the first elongate body 114 is disposed in the third lumen. The cooling element 117 may be configured to circulate a non-heated fluid (e.g., ambient air, cooled air, coolant) through the third lumen using a pump to cool the distal portion of the first elongate body 114. The third elongate body 119 may be fluidically coupled to the cooling element 117. The non-heated fluid may be circulated to the cooling element 117 through the third elongate body 119.

The position sensor 118 (e.g., linear measurement sensor) may be configured to generate a position signal corresponding a position of the welding rod within the feeder 110 and/or a welding rod signal corresponding to a presence of the welding rod disposed in the first elongate body 114. The position signal may be used to aid cutting of the welding rod by the cutter 130, as described in more detail herein.

In some variations, the heater 120 may be configured to heat the welding rod to a predetermined temperature for welding onto the substrate. The heater 120 may comprise one or more of a gas source 122, a second elongate body 124, an outlet 125, a heating element 126, a valve, and a temperature sensor 128. The gas source 122 may be configured to provide a predetermined gas flow through the second elongate body 124 based on a temperature signal and a set of weld parameters. In some variations, the gas source 122 (e.g., compressed air, fan, air compressor) may be coupled to a proximal end of the second elongate body 124. The heating element 120 may be comprise one or more of ceramic and quartz. The heating element 126 may be configured to heat the gas flowing in the heater 120 to a predetermined temperature based on the temperature signal and the set of weld parameters. In some variations, the heating element 126 may be housed within the second elongate body 124. The temperature sensor 128 may be configured to generate a temperature signal corresponding to a temperature of one or more of the first elongate body 114, second elongate body 124, welding rod, weld, and substrate. In some variations, the temperature sensor 128 may comprise a plurality of temperature sensors configured to generate a plurality of temperature signals for a plurality of components of the welding system 100. The valve 127 may be configured to control the gas flow (e.g., flow rate) through a lumen and outlet 125 of the second elongate body 124. The valve 127 may adjust the gas flow based on a temperature signal and a set of weld parameters. Adjusting the gas flow may maintain a predetermined temperature of the welding rod.

In some variations, the heating element 126 may be configured to heat gas to a predetermined temperature based on a temperature signal and a set of weld parameters. In some variations, the heating element 126 may be housed within the second elongate body 124. The heating element 126 may comprise one or more of ceramic and quartz. In some variations, one or more of the heating element 126 and the second elongate body 124 may comprise thermal insulation to reduce unintentional heating of the welding system 100. In some variations, the heating element 126 may be disposed at a distal end of the second elongate body 1242. In some variations, the heating element 126 may be distal and/or parallel to the cutter 130.

Weldment quality and cosmetic appearance of the weldment may be improved by evenly heating the substrate and welding rod to predetermined temperatures. In some variations, outlet 125 may comprise a plurality of outlets for precise temperature control of the welding rod and the substrate as described in more detail herein.

In some variations, the cutter 130 may be configured to cut the welding rod disposed within the feeder 110. Accordingly, the length of a weld may be determined by the cutter 130. In some variations, a position signal measured by the position sensor 118 and a set of weld parameters may be used to control the cutter 130 as described in more detail herein. The cutter 130 may be coupled (e.g., directly attached) to one or more of the feeder 110, heater 120, and end effector connector 142.

In some variations, the cutter 130 may be configured to cut the welding rod between a proximal end and the distal end of the feeder 110. For example, the cutter 130 may be configured to cut an unheated portion of the welding rod disposed within an aperture of the first elongate body 114. In some variations, the cutter 130 may be non-parallel to a longitudinal axis of the first elongate body 114. For example, the cutter 130 may be angled up to about 60 degrees relative to the longitudinal axis of the first elongate body 114. In some variations, the cutter 130 may comprise one or more cutting elements, such as blades, scissors, and the like.

In some variations, the robotic arm 140 may be configured to moveably suspend, hold, and/or operate a welding head including the feeder 110, heater 120, and cutter 130 relative to a substrate (e.g., work product on a platform 146) based on one or more sensor measurements (e.g., position signal, temperature signal, image signal) and a set of weld parameters (e.g., size, shape, geometry, material, temperature). The robotic arm 140 may comprise an end effector connector 142 configured to physically connect a distal end of the robotic arm 140 to the welding head. In some variations, the end effector connector 142 may comprise or be coupled to a joint 190. The robotic arm 140 may further comprise a base 144 coupled to a proximal end of the robotic arm 140.

In some variations, the joint 190 may be coupled to one or more of the feeder 110, the heater 120, and the cutter 130 such that the joint 190 is configured to rotate the feeder 110, the heater 120, and the cutter 130 relative to the end effector connector 142 (e.g., by up to about 90 degrees). In some variations, the joint 190 may comprise a gear and a motor configured to drive the gear. In some variations, the joint 190 may be configured to rotate based on an attack angle of a weld.

In some variations, the platform 146 may be configured to hold a substrate to be welded by the welding system 100. In some variations, the platform 146 may be configured to move relative to the robotic arm 140 to provide additional degrees of freedom to facilitate a complex welding geometry. For example, the platform 146 may be configured to rotate (e.g., as a turntable) and/or pivot (e.g., roll, pitch, yaw).

In some variations, the processor 170 and memory 172 operatively coupled to the processor 170 may be configured to control the welding system 100 and perform one or more of the functions and methods described herein. In some variations, the input device 180 may be configured to receive input (e.g., commands, data) from an operator, the output device 182 may be configured to output data (e.g., display temperature data, weld images, notifications), and the communication device 184 may be configured to transmit data between the welding system 100 and one or more compute devices (e.g., server, database, PC, laptop).

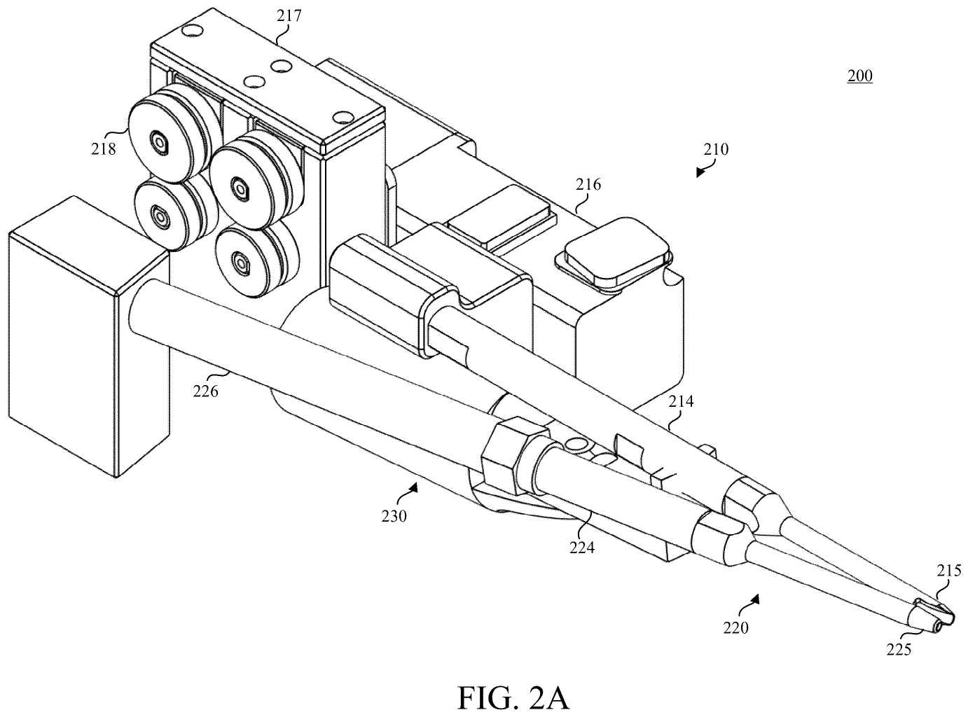

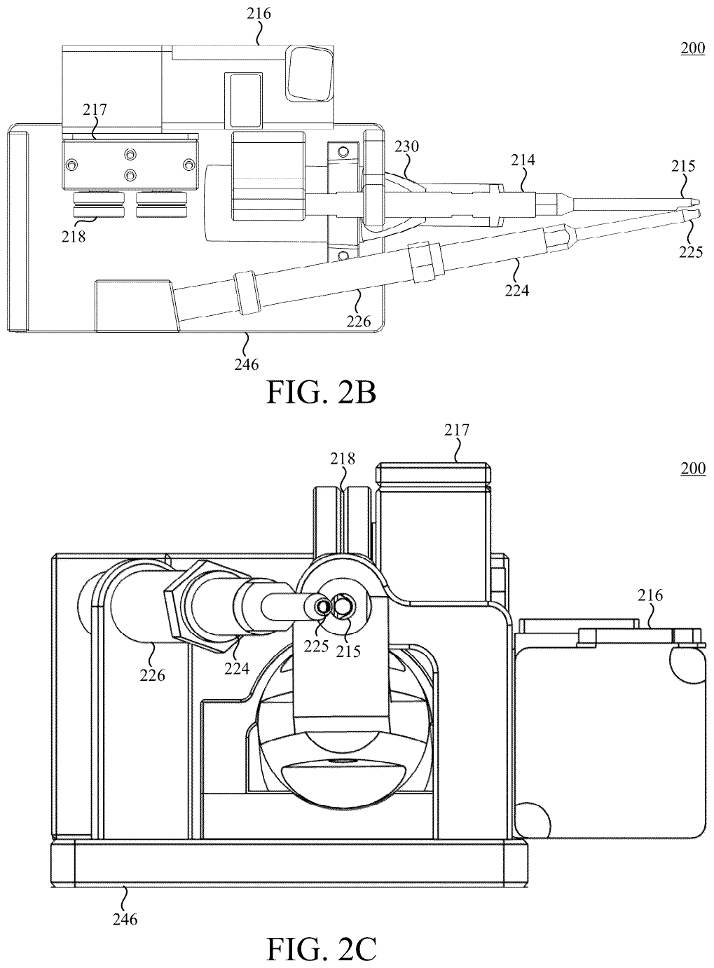

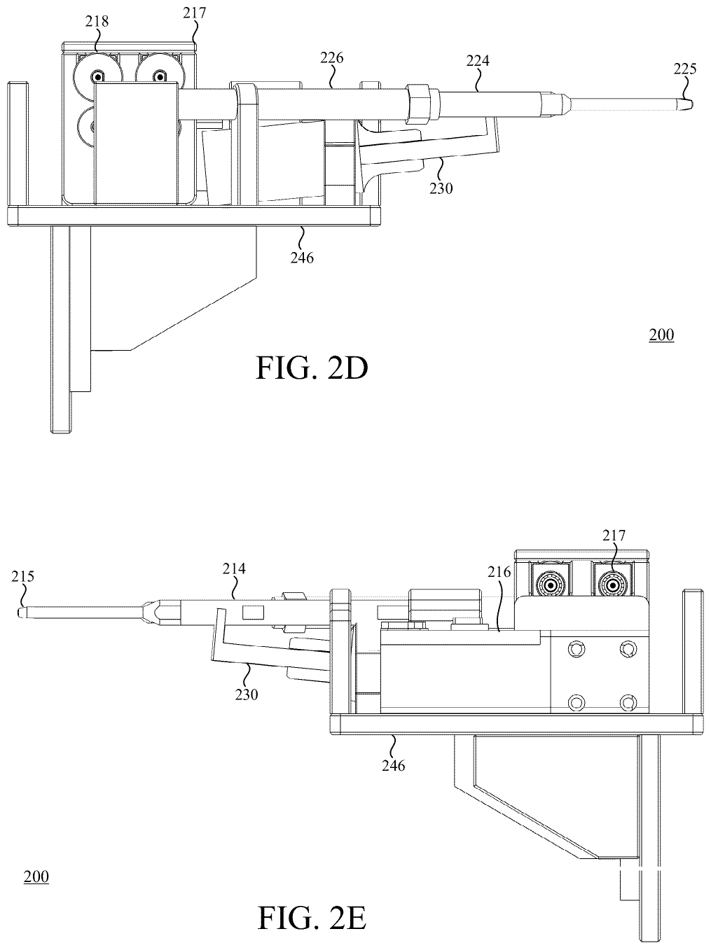

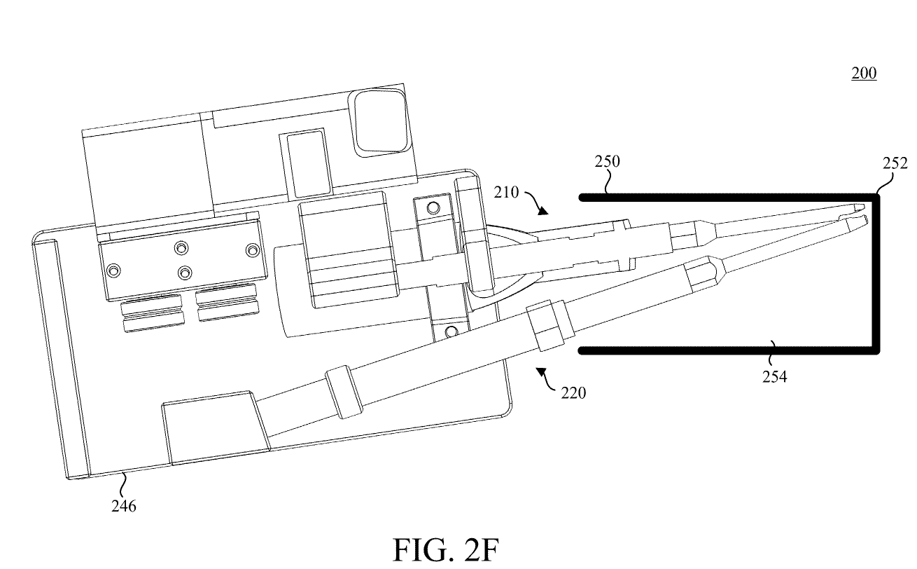

FIG. 2A depicts a perspective view of an exemplary welding system 200. FIG. 2B depicts a top view of the exemplary welding system 200. FIG. 2C depicts a front view of the exemplary welding system 200. FIG. 2D depicts a left side view of the exemplary welding system 200. FIG. 2E depicts a right side view of the exemplary welding system 200. FIG. 2F depicts a top view of an exemplary welding system 200 relative to a substrate 250. For example, the exemplary welding system 200 of FIG. 2A illustrates a feeder 210, a heater 220, and a cutter 230. In some variations, the feeder 210 may comprise a set of rollers 218 coupled to an actuator 216. The set of rollers 218 may be configured to advance a welding rod (not shown) into and through the first elongate body 214 of the feeder 210 and out of the first outlet 215. The heater 220 may comprise a second elongate body 224, a heating element 226, and at least a second outlet 225.

The feeder 210 may comprise a first elongate body 214 and an actuator 216. The first elongate body 214 may define a first lumen and a first outlet 215 (e.g., nozzle). The actuator 216 may comprise a motor configured to rotate the set of rollers 218 via a gear drive 217. The gear drive 217 may be coupled between the set of rollers and the actuator 216. Additionally or alternatively, the feeder 210 may comprise a reel (not shown) coupled to the actuator 216. The welding rod may be wound around the reel where the reel may be configured to advance a welding rod into and through the first elongate body 214. A die (not shown) may be coupled to a proximal end of the set of rollers 218. A welding rod may be advanced sequentially through the die, the set of rollers 218, the first elongate body 214, and the first outlet 215 using, for example, the set of rollers 218 and the actuator 216. The first outlet 215 may define an aperture at a distal end of the first elongate body 214 and along a sidewall of the first elongate body 214 facing the heater 220. The first outlet 215 extending along a sidewall may facilitate heating of the welding rod by the heater 220 before placement on a substrate.

The feeder 210 may define a first longitudinal axis (e.g., a longitudinal axis of the first elongate body) and the heater 220 may define a second longitudinal axis (e.g., a longitudinal axis of the second elongate body 224). In some variations, an angle between a first longitudinal axis and the second longitudinal axis may be between 1 degree and about 15 degrees, between 1 degree and about 14 degrees, between 1 degree and about 13 degrees, between 1 degree and about 12 degrees, between 1 degree and about 11 degrees, and between 1 degree and about 10 degrees, including all ranges and sub-values in-between. This angle and configuration of the feeder 210 and heater 220 facilitates weldments within narrow cavities (e.g., deep pockets, undercuts) and thus improves flexibility (e.g., reach, access) of the welding system over conventional welding systems techniques and provides capabilities beyond the dexterity of human free-hand welders holding a heater and feeder in each hand. For example, FIG. 2F illustrates a distal end of a feeder 210 and heater 220 disposed in sufficient proximity to weld location 252 in order to from a weld at weld location 252 within the narrow cavity 254 of a substrate 250. In particular, the compact configuration (e.g., placement of components, angle between feeder 210 and heater 220) of the welding head (e.g., feeder 210, heater 220, cutter 230) facilitates a welding range greater than those achievable with manual welders who lack the dexterity, strength, precision, flexibility, efficiency, and scalability provided by the welding systems described herein. Furthermore, conventional systems are bulky and do not possess the geometry to extend into narrower cavities such that they are only capable of welding on outward facing substrate surfaces.

FIGS. 2D and 2E depict the end effector connector 246 coupled to the feeder 210, heater 220, and cutter 230 (collectively referred to as a welding head). The end effector connector 246 may be configured to releasably connect a welding head to a robotic arm (not shown). In this manner, different welding heads may be rapidly exchanged, thereby enabling different welds to be formed. For example, a first welding head may be configured to feed a single circular welding rod while a second welding head may be configured to feed a set of three welding rods forming a triangular shape with a greater diameter than the single circular welding rod, and a third welding head may be configured to feed a set of two welding rods forming an ellipsoid shape having a longitudinal axis with a greater diameter than the single circular welding rod.

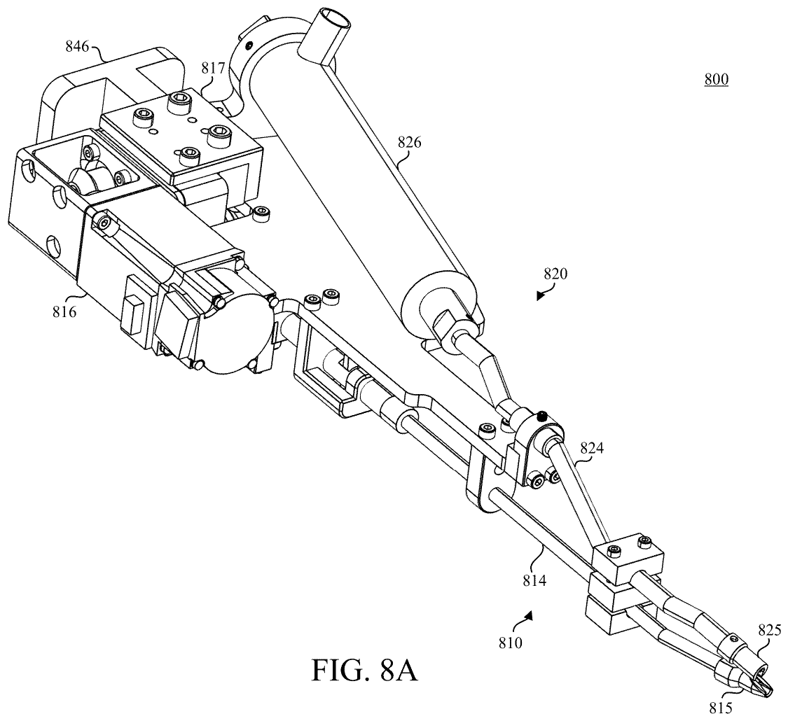

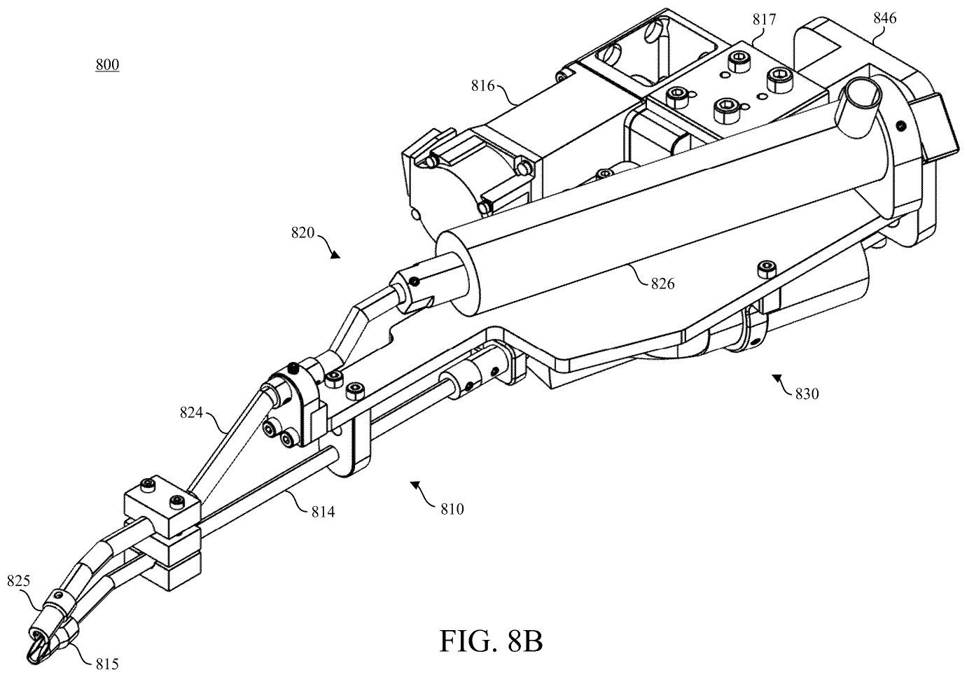

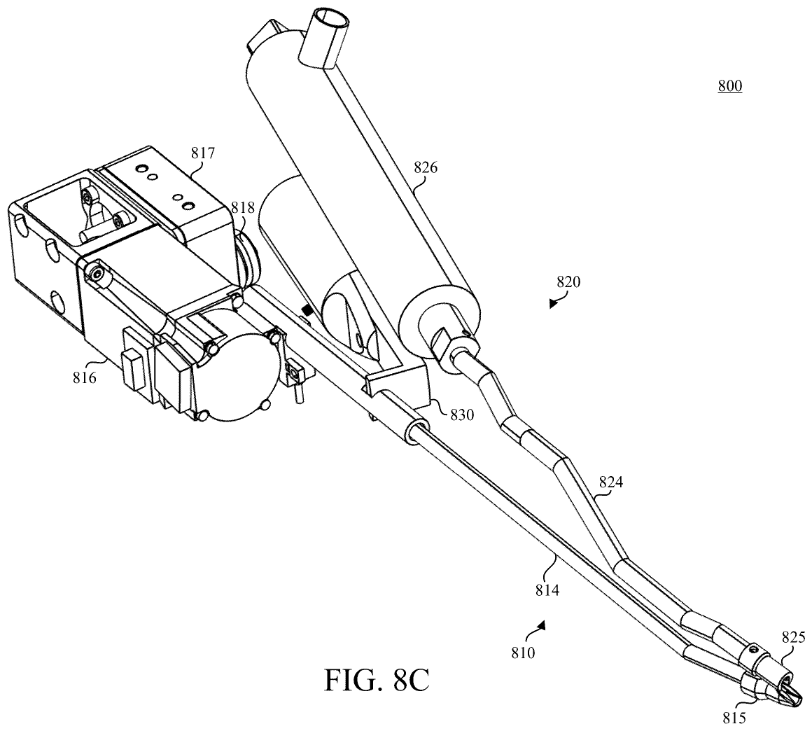

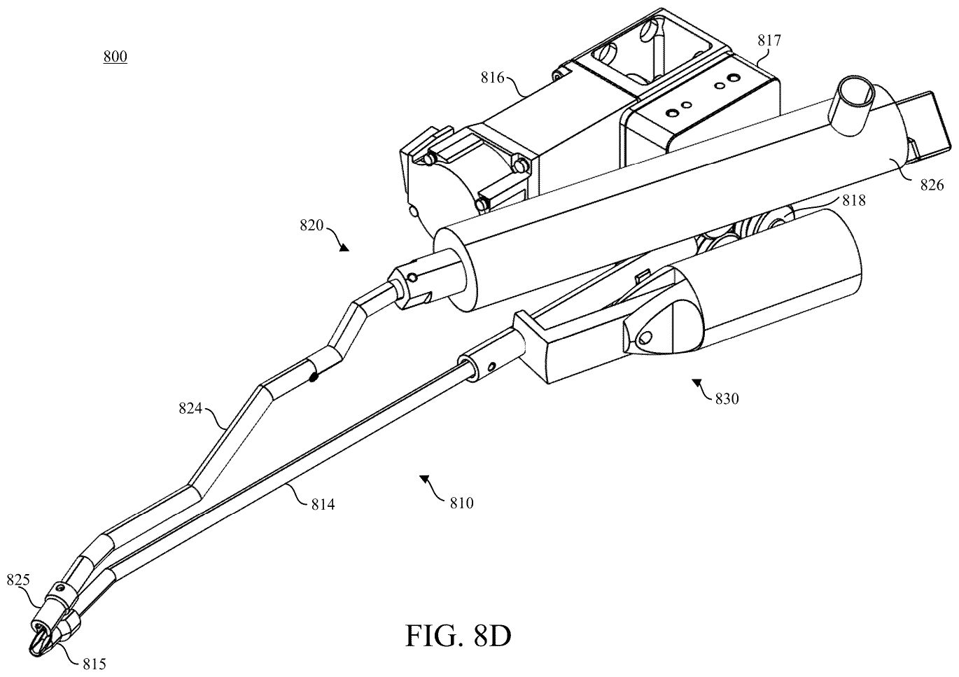

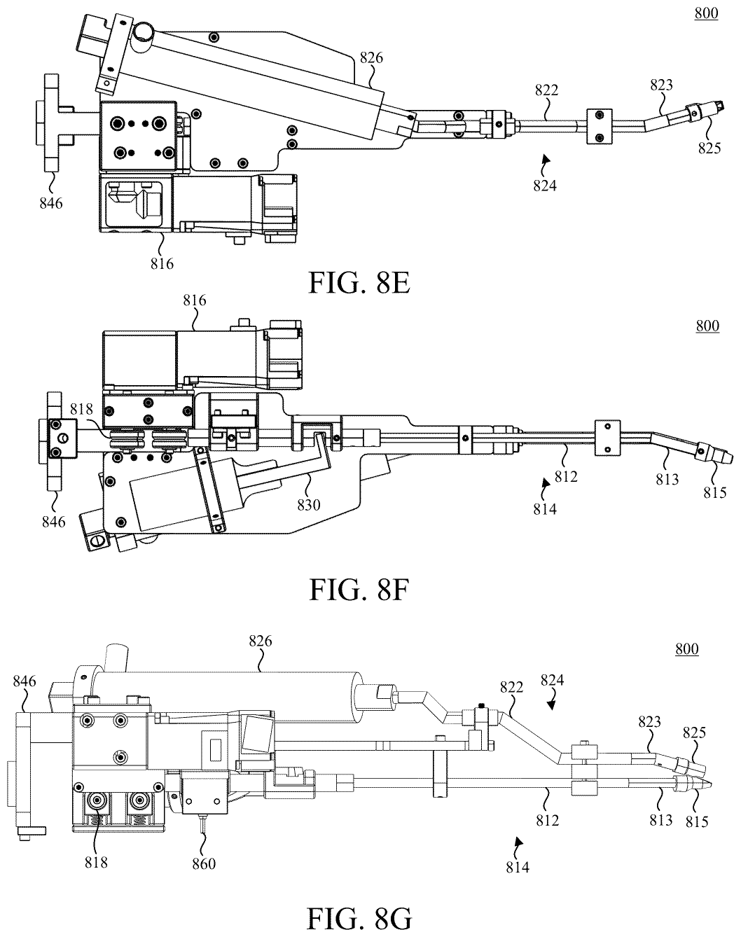

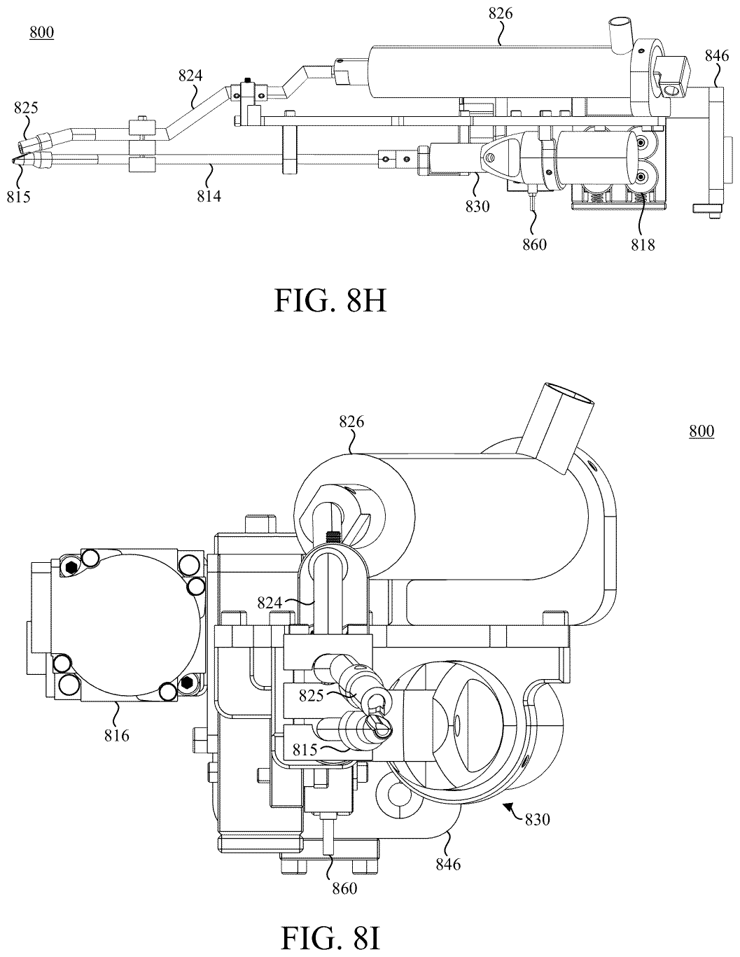

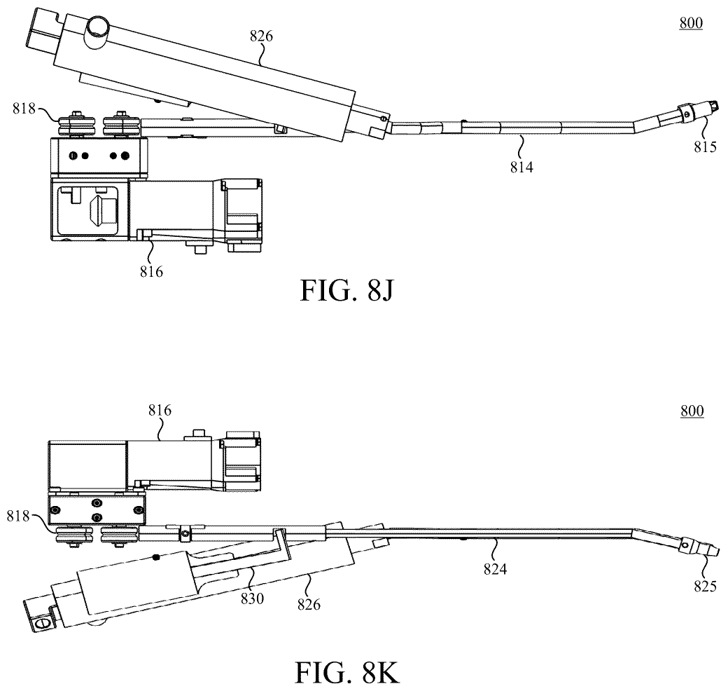

The welding systems described herein may be used to generate a set of polymer welds (e.g., thermoplastic) on a substrate. FIGS. 8A and 8B depict perspective views of an exemplary welding system 800 having elements similar to those described with respect to FIGS. 2A-2F. The welding system 800 may comprise a feeder 810, a heater 820, and a cutter 830. The feeder 810 may be configured to advance a welding rod to the substrate (not shown for the sake of clarity). The heater 820 may be configured to heat the welding rod or substrate to a predetermined temperature. The cutter 830 may be configured to cut the welding rod to terminate the weld.

A feeder 810 may advance a welding rod and a heater 820 may heat the welding rod to form a weld. FIGS. 8C and 8D depict perspective views of an exemplary welding system 800 with some components not shown for the sake of clarity. In some variations, the feeder 810 may comprise an actuator 816. The actuator 816 may be configured to advance a welding rod (not shown) into and through the first elongate body 814 of the feeder 810 and out of the first outlet 815. The feeder 810 may comprise a first elongate body 814 and an actuator 816. The first elongate body 814 may define a first lumen and a first outlet 815 (e.g., nozzle, feeder nozzle). The actuator 816 may comprise a motor configured to rotate the set of rollers 818 via a gear drive 817. The gear drive 817 may be coupled between the set of rollers and the actuator 816. Additionally or alternatively, the feeder 810 may comprise a reel (not shown) coupled to the actuator 816. The welding rod may be wound around the reel where the reel may be configured to advance a welding rod into and through the first elongate body 814. A die (not shown) may be coupled to a proximal end of the set of rollers 818. A welding rod may be advanced sequentially through the die, the set of rollers 818, the first elongate body 814, and the first outlet 815 using, for example, the set of rollers 818 and actuator 816. The first outlet 815 may define an aperture at a distal end of the first elongate body 814 and along a sidewall of the first elongate body 814 facing the heater 820. The aperture of the first outlet 815 extending along the sidewall may facilitate heating of the welding rod by the heater 820 before placement on a substrate.

The heater 820 may comprise a second elongate body 824, a heating element 826, and a second outlet 825. The heating element 826 may be configured to heat a fluid (e.g., gas) to a predetermined temperature. The gas may flow through the second elongate body 824 and be output at the second outlet 825. The second outlet 825 may facilitate heating of one or more of the welding rod and substrate to a predetermined temperature. The welding rod advanced by the feeder 810 and heated by the heater 820 may form a weld on the substrate.

An increased range of attack angles relative to conventional techniques may be provided by angling a distal end of the first elongate body 814 and second elongate body 824. For example, a robotic arm coupled to a conventional linear weld head may not be able to provide a desired attack angle (e.g., 90 degrees on an external weld, 45 degrees on an internal weld) because of rotational limitations of a robotic arm (e.g., singularities) or inability to access a substrate with restrictive geometries (e.g., deep cavity, narrow pocket). FIGS. 8E and 8F depict a respective top and bottom view of an exemplary welding system 800 having a distal portion that provides an increased range of attack angles. In some variations, the first elongate body 812 comprises a first portion 812 and a second portion 813 distal to the first portion 812. In some variations, the first portion 812 is proximal to the second portion 813, and the first portion 812 comprises a first length and the second portion 813 comprises a second length shorter than the first length.

The first portion 812 defines a first longitudinal axis and the second portion 813 is non-parallel to the first longitudinal axis of the first elongate body 814. In some variations, the second portion 813 is angled up to about 5 degrees, up to about 10 degrees, up to about 15 degrees, up to about 20 degrees, up to about 25 degrees, up to about 30 degrees, between about 10 degrees and about 20 degrees, between about 15 degrees and about 30 degrees, and between about 30 degrees and about 60 degrees relative to the first longitudinal axis of the first elongate body 814 (e.g., first portion 812), including all ranges and sub-values in-between (not including zero degrees). Similarly, the second elongate body 824 of heater 820 may comprise a third portion 822 and a fourth portion 823 distal to the third portion 822. The third portion 822 defines a second longitudinal axis and the fourth portion 823 is non-parallel to the second longitudinal axis of the second elongate body 824. In some variations, the fourth portion 823 is angled up to about 5 degrees, up to about 10 degrees, up to about 15 degrees, up to about 20 degrees, up to about 25 degrees, up to about 30 degrees, between about 10 degrees and about 20 degrees, between about 15 degrees and about 30 degrees, and between about 30 degrees and about 60 degrees relative to the second longitudinal axis of the second elongate body 824 (e.g., third portion 822), including all ranges and sub-values in-between (not including zero degrees).

Temperature control of the welding rod may be improved by adding one or more bends to a second elongate body 824. FIGS. 8G and 8H depict a respective left side and right side view of an exemplary welding system 800. As shown in FIG. 8G, the second elongate body 824 may define a plurality of bends that progressively increase the distance between the second elongate body 824 and the first elongate body 814. The distance between the second elongate body 824 and the first elongate body 814 at a proximal portion of the welding system 800 may reduce proximal heating of at least the welding rod by the heater 826 and second elongate body 824, thereby reducing clogging of the first elongate body 814 and reducing thermal damage to other components of the welding system 800.

In some variations, the welding systems described herein may enable welds in substrates with restrictive geometries (e.g., sharp internal angles, deep pockets, narrow cavities) by minimizing separation between the distal ends of the feeder and heater. Conventional solutions are too bulky and/or heavy to have a configuration (e.g., geometry) capable of reaching into narrower cavities such that they are generally capable of welding only on exterior-facing substrate surfaces. FIGS. 8I, 8J, and 8K depict a respective front view, top view, and bottom view of an exemplary welding system. In some variations, an angle between the first outlet 815 and the second outlet 825 may be less than about 30 degrees, less than about 20 degrees, less than about 15 degrees, less than about 12 degrees, less than about 10 degrees, and less than about 5 degrees, including all ranges and sub-values in-between (not including zero degrees). The narrowing geometry (e.g., size, shape) of the welding system 800 from a proximal end to a distal end facilitates weldments within narrow cavities (e.g., deep pockets, undercuts) and thus improves flexibility of the welding system over conventional welding techniques so as to provides capabilities beyond the dexterity of human free-hand welders holding a heater and feeder in each hand. The compact configuration (e.g., placement of components, angle between feeder 810 and heater 820) of the welding head facilitates a welding range greater than those achievable with manual welders who lack the dexterity, strength, endurance, precision, flexibility, efficiency, repeatability, and scalability provided by the welding systems described herein. For example, a longitudinal axis of the cutter 830 may be about parallel to a longitudinal axis of the heating element 826 to facilitate a more compact configuration. In some variations, most components of the welding head may be disposed on one side of the first elongate body 814 to facilitate a more compact configuration.

FIGS. 8E-8I depict the end effector connector 846 coupled to the feeder 810, heater 820, and cutter 830 (collectively referred to as a welding head). The end effector connector 846 may be configured to releasably connect a welding head to a robotic arm (not shown). In this manner, different welding heads may be rapidly exchanged, thereby enabling different welds to be formed. For example, a first welding head may be configured to feed a single circular welding rod while a second welding head may be configured to feed a set of three welding rods forming a triangular shape with a greater diameter than the single circular welding rod, and a third welding head may be configured to feed a set of two welding rods forming an ellipsoid shape having a longitudinal axis with a greater diameter than the single circular welding rod.

### A. Feeder

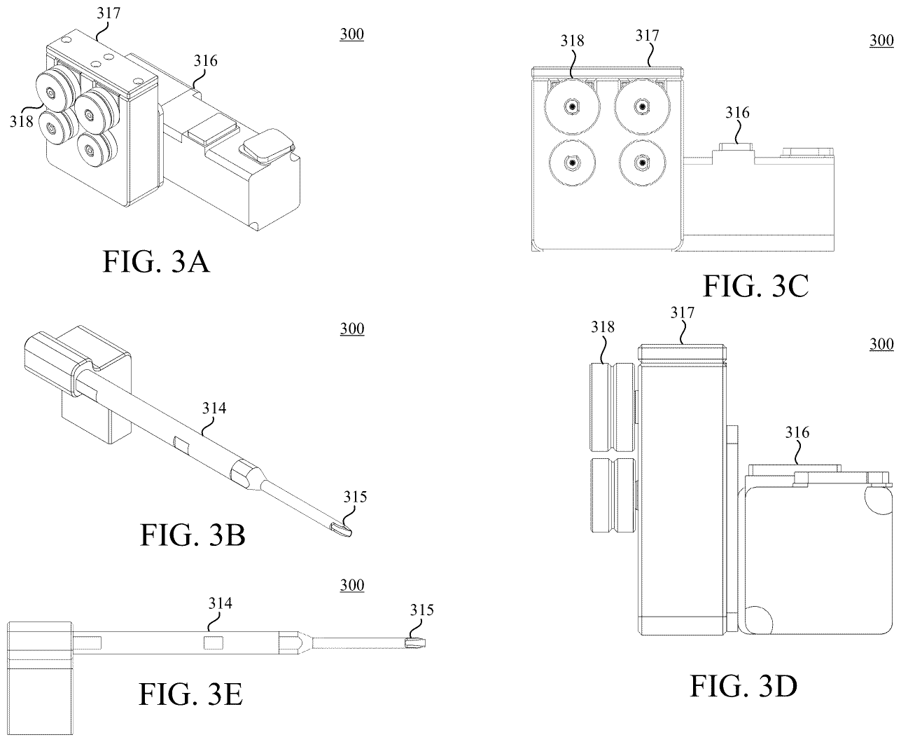

The welding systems described herein may comprise a feeder configured to advance a welding rod to a substrate while facilitating heating and cutting of the welding rod while being mounted on a robotic arm. FIG. 3A depicts a perspective view of an actuator 316 of an exemplary feeder 300 of a welding system. The actuator 316 (e.g., servo motor) may be coupled to a set of rollers 318 via a gear drive 317 (e.g., gear driven pulley). FIG. 3B depicts a perspective view of a first elongate body 314 of an exemplary feeder 300 of a welding system. The first elongate body 314 may define a first lumen and a first outlet 315. The first outlet 315 may define an aperture at a distal end of the first elongate body 314 and along a sidewall of the first elongate body 314 facing a heater (not shown in FIGS. 3A-3E). FIG. 3C depicts a side view of the actuator 316 of the exemplary feeder 300. FIG. 3D depicts a front view of the actuator 316 of the feeder 300. FIG. 3E is side view of the first elongate body 314 of the exemplary feeder 300.

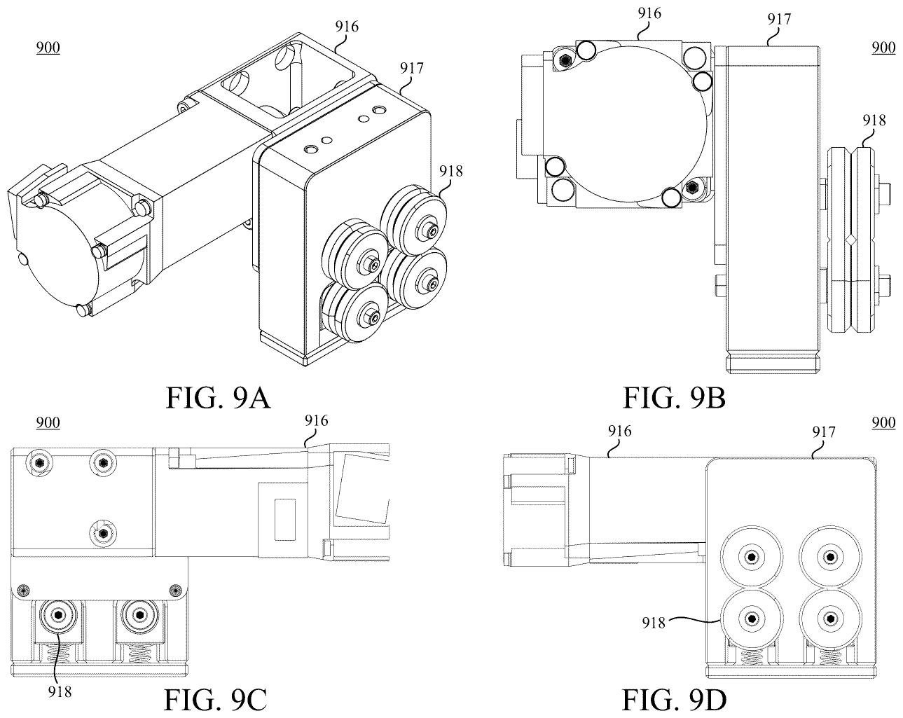

A feeder may be configured to advance a welding rod via an actuator 916, a gear drive 917, and a set of rollers 918. FIG. 9A depicts a perspective view of an actuator 916 of an exemplary feeder 900 of a welding system. The actuator 916 (e.g., servo motor) may be coupled to a set of rollers 918 via a gear drive 917 (e.g., gear driven pulley). The set of rollers 918 may contact a welding rod to advance the welding rod. FIG. 9B depicts a front view of an actuator 916 of an exemplary feeder 900 of a welding system. FIG. 9C depicts a left side view of an actuator 916 of an exemplary feeder 900 of a welding system. FIG. 9D depicts a right side view of an actuator 916 of an exemplary feeder 900 of a welding system. Each roller of the set of rollers 918 may be coupled to a spring to facilitate contact with welding rods of differing diameter or cross-sectional shape.

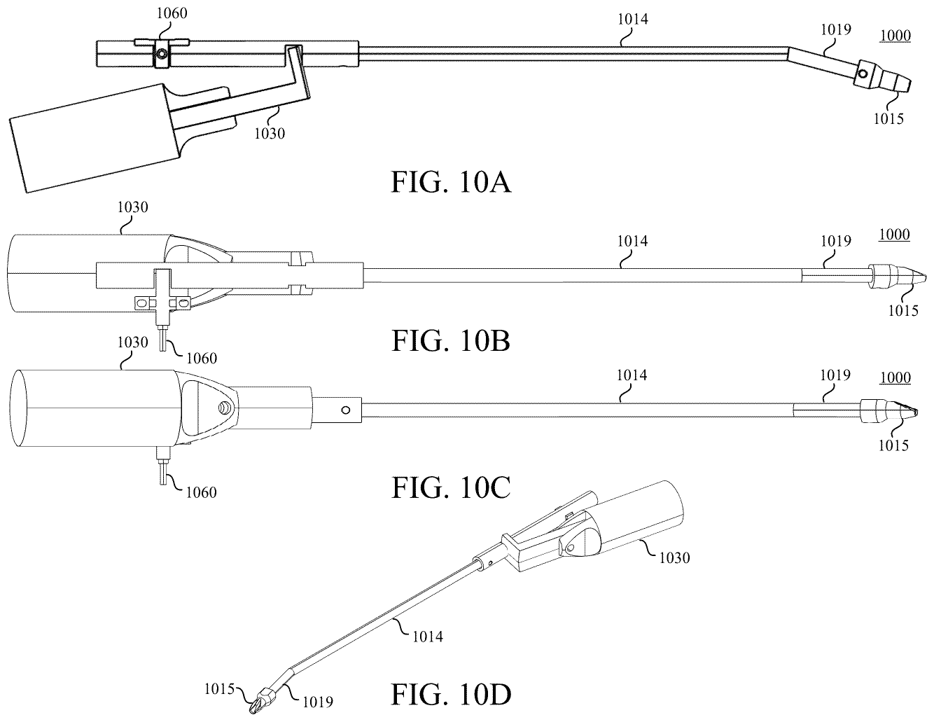

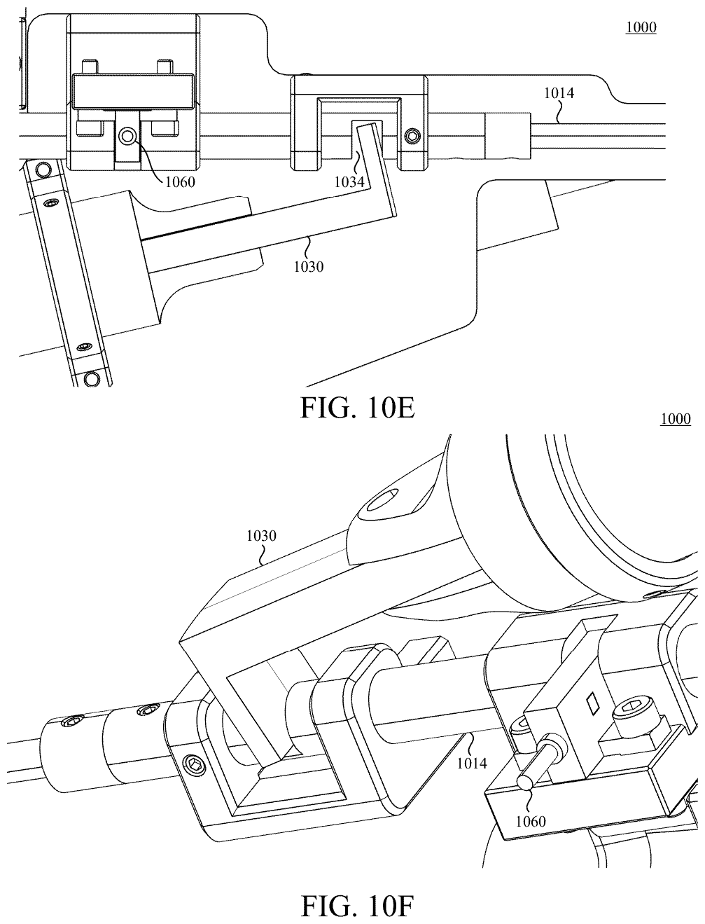

A feeder may be configured to advance a welding rod through an elongated body while facilitating sensing and cutting of the welding rod disposed within the elongate body. FIG. 10A depicts a bottom view of a feeder tube 1014 (first elongate body) and a cutter 1030 of an exemplary welding system. The first elongate body 1014 may define a first distal end 1019 and first outlet 1015. In some variations, the distal end of the first elongate body 1019 may be angled relative to a first longitudinal axis of the first elongate body 1014 to approach an attack angle. For example, the distal end 1019 of the first elongate body may be angled up to about 45 degrees, up to about 30 degrees, and up to about 15 degrees away from the first longitudinal axis of the first elongate body 1014 (not including zero degrees). FIG. 10B depicts a left side view of a feeder tube 1014 (first elongate body) and a cutter 1030 of an exemplary welding system. The first elongate body 1014 may define a first aperture configure to receive the cutter 1030. The first elongate body 1014 may define a second aperture configured to receive a position sensor 1060. The second aperture may be proximal to the first aperture. FIG. 10C depicts a right side view of a feeder tube 1014 (first elongate body) and a cutter 1030 of an exemplary welding system. FIG. 10D depicts a perspective view of a feeder tube 1014 (first elongate body) and a cutter 1030 of an exemplary welding system.

The welding rods described herein may refer to one or more welding rods. For example, one, two, three, or more welding rods may be advanced together through a feeder and heated by a welding system to form a respective single, double, and triple bead weld. In some variations, a single welding rod may have a generally circular cross-section. A double bead weld may comprise two welding rods in side-by-side contact advanced and heated together. A triple bead weld may comprise three welding rods in contact to form a generally triangular cross-section. In this manner, the welding systems described herein may form a triple bead weld in a single pass compared to conventional methods of applying a single bead over the same portion of a substrate three times to form the triple bead weld.

The feeders described herein may be configured to receive a welding rod of a predetermined shape and diameter. For example, the welding rods may have circular cross-section or any cross-sectional shape (e.g., triangular, square). In some variations, the welding rods may comprise a diameter of between about 0.1 mm and about 5 mm (e.g., about 1.6 mm, about 2 mm, about 3.2 mm, about 4.75 mm), including all ranges and sub-values in-between. The welding rod may comprise a polymer as described herein, such as a thermoplastic material (e.g., semi-crystalline, amorphous). While FIGS. 2-5 depict exemplary elongate bodies configured to receive cylindrical welding rods, the first elongate body 114 may be configured to receive and output a welding rod having a triangular cross-section or any predetermined cross-sectional shape.

In some variations, the feeder may be configured to feed the welding rod to a substrate at a predetermined rate based on one or more weld parameters. For example, the predetermined rate may comprise a speed of between about 0.5 mm/sec and about 20 mm/sec.

### B. Heater

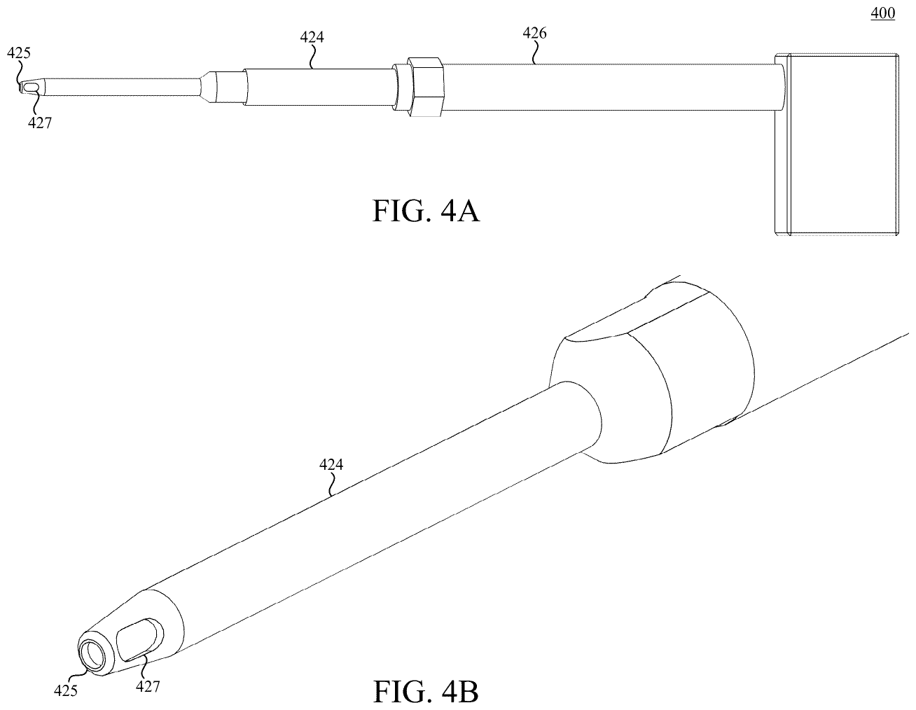

The welding systems described herein may comprise a heater configured to heat a welding rod to a predetermined temperature for forming a weldment. FIG. 4A depicts a side view of an exemplary heater 400 of a welding system. FIG. 4B depicts a perspective view of an exemplary heater 400 of a welding system. The heater 400 may comprise a gas source (not shown), a second elongate body 424, and a heating element 426. The heater 400 may be configured to output heated gas at a predetermined flow rate. In some variations, the second elongate body 424 may define a second lumen, a second outlet 425, and a third outlet 427. For example, the second elongate body 424 may comprise a sidewall defining the third outlet 427 facing a feeder (not shown). In this manner, the third outlet 427 may be configured to heat the welding rod advanced by a feeder at a first predetermined temperature and the second outlet 425 may be configured to melt the welding rod at a second predetermined temperature. That is, the third outlet 427 may preheat the welding rod and the second outlet 425 may provide additional heating to melt the welding rod for forming a weldment on a substrate. In some variations, the welding rods may comprise a softening point of above about 100° C., and a melting point of between about 100° C. and about 150° C., between about 150° C. and about 200° C., between about 200° C. and about 250° C., between about 250° C. and about 300° C., between about 300° C. and about 350° C., between about 350° C. and about 400° C., and between about 100° C. and about 400° C., including all ranges and sub-values in-between.

In some variations, the second outlet 425 may comprise a diameter of between about 1.0 mm and about 3.0 mm, including all ranges and sub-values in-between. In some variations, the third outlet 427 may comprise an angle with respect the longitudinal axis of the second elongate body 424 of between about 10 degrees and about 30 degrees, including all ranges and sub-values in-between. In some variations, the second outlet 425 may comprise an elongate shape (e.g., oblong, ovular, rectangular, ellipsoid) having a width of between about 1.0 mm and about 3.0 mm and/or a length of between about 1.0 mm and about 4.0 mm, including all ranges and sub-values in-between.

In some variations, the heating element 426 may be disposed within the second lumen of the second elongate body 424. For example, the heating element may comprise a coiled cylindrical tube formed of one or more of ceramic and quartz. In some variations, the gas source may be coupled in fluid communication with a proximal end of the second elongate body 424. The gas source may comprise one or more of a pump (e.g., air compressor), compressed air (e.g., clean dry air), a fan, fluid reservoir, combinations thereof, and the like. In this manner, the heater 420 may heat the gas flowing through the second elongate body 424 to facilitate a welding process.

In some variations, the heating element 426 may be disposed at the distal end of the second elongate body to improve the efficiency of the welding system. A heating element disposed a proximal end of the welding head or outside the welding head may cause significant temperature reduction of the gas (e.g., a loss of one third of heat input by the heating element 426) between the heating element 426 and the second outlet 425. In some variations, a heating element at the distal end of the heater 400 may be smaller than a heating element 426 at the proximal end of the heater. A smaller heater and a shorter second elongate body 424 may reduce the amount of heat lost between the heating element 426 and the second outlet 425.

In some variations, closed-loop welding temperature control enables automatic adjustment of welding temperature through embedded temperature measurement, gas flow control, and temperature control. In some variations, the heater 400 may comprise one or more temperature sensors configured to generate a temperature signal corresponding to a temperature of one or more of the second elongate body 424, the welding rod, and a substrate. In some variations, a temperature sensor may comprise one or more of a thermocouple, infrared sensor, and laser sensor. In some variations, a processor of the welding system may be configured to receive the temperature signal and a set of weld parameters, and select one or more parameters of the gas source and heating element based on the temperature signal and the set of weld parameters. For example, one or more of a gas flow rate and a temperature (e.g., power output of a heating element) may be adjusted based on the temperature signal and weld parameters. For example, the heater 400 may be configured to generate a flow rate of up to about 500 L/min ANR, up to about 750 L/min ANR, up to about 1,000 L/min ANR, up to about 1250 L/min ANR, and up to about 1,500 L/min Atmosphere Normale de Reference (ANR), including all ranges and sub-values in-between, at a pressure of about 0.9 MPa. In some variations, the heating element 426 may comprise a wattage output of up to about 500 Watts, up to about 1000 Watts, up to about 1200 Watts, up to about 1500 Watts, and up to about 1800 Watts, including all ranges and sub-values in-between. In some variations, the heating element 426 may be configured to increase from ambient temperature to about 380° C. in between about 30 seconds and about 50 seconds, and may decrease from about 380° C. to ambient temperature in between about 60 seconds and 120 seconds.

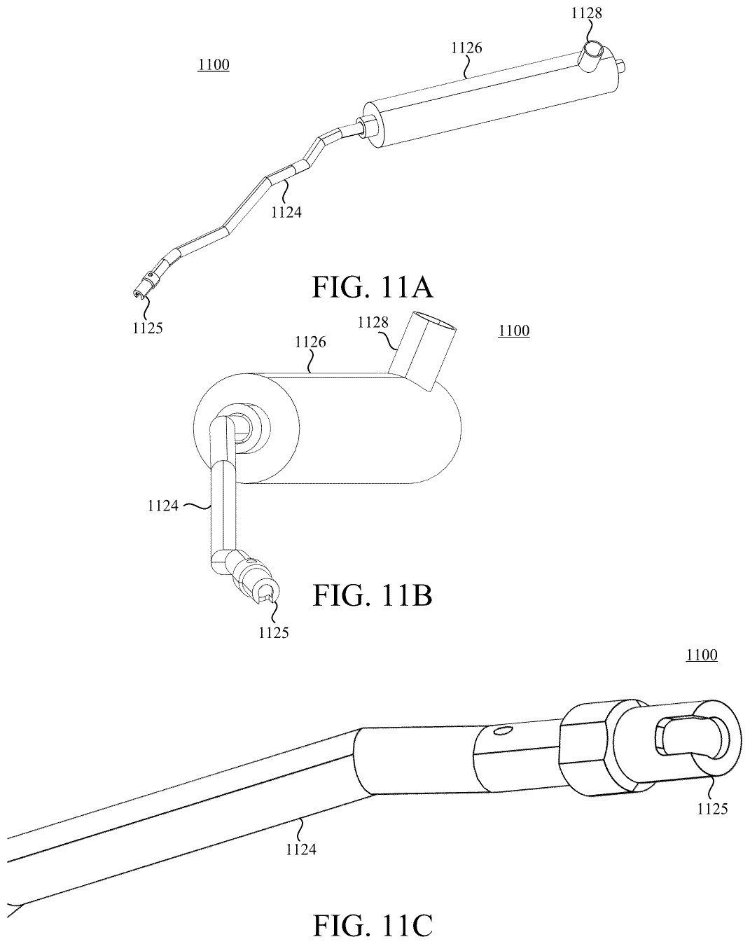

The welding systems described herein may comprise a heater configured to heat a welding rod to a predetermined temperature for forming a weldment. FIGS. 11A and 11B depict respective perspective and front views of an exemplary heater 1100 of a welding system. The heater 1100 may comprise a heating element 1126 coupled to a second elongate body 1124 and a valve 1128. The valve 1128 may be coupled to a gas source (not shown). The second elongate body 1124 may define a lumen and an outlet 1125 (e.g., heater nozzle). The second elongate body 1124 may be configured to reduce premature heating of a welding rod disposed within a feeder. For example, the second elongate body 1124 may define one or more bends to maintain a predetermined distance between the heater 1100 and feeder to reduce undesirable heat transfer. For example, a distance between the heater 1126 and a proximal portion of the feeder may be greater than a distance between an outlet of the feeder and the outlet 1125 of the heater 1100. between to a proximal portion of the feeder. As described herein, the heater 1100 may be configured to output heated gas at a predetermined flow rate. In some variations, the valve may be configured to adjust the flow rate of gas. FIG. 11C depicts a detailed bottom of view of a heater nozzle 1125 of an exemplary heater 1100. The outlet 1125 may be configured to heat the welding rod advanced by a feeder at a predetermined temperature.

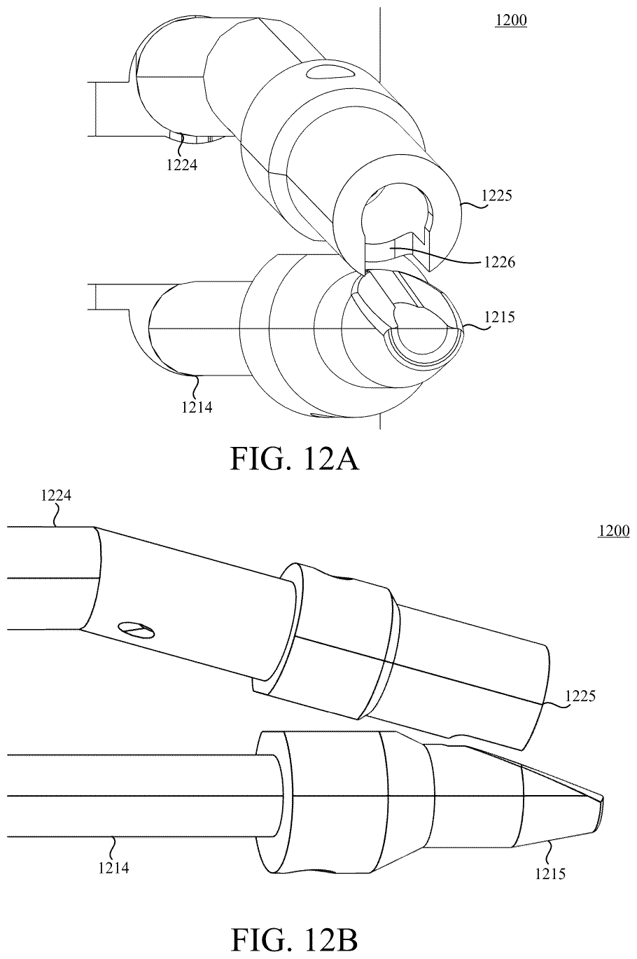

FIGS. 12A and 12B depict respective front and left side views of a distal end of a welding system 1200 (e.g., welding head) including a feeder outlet 1215 (e.g., first outlet) and a heater outlet 1225 (e.g., second outlet). In some variations, the first outlet 1215 defines an aperture at a distal end of a first elongate body 1214 and along a sidewall of the first elongate body 1214 facing the second outlet 1225 of the heater. As shown in FIG. 12B, the second outlet 1225 may be proximal to the first outlet 1215, and the first outlet 1215 and the second outlet 1225 are non-parallel. In some variations, the second outlet 1225 is positioned within about 2 cm of the first outlet 1215 to reduce a size of a distal end of the welding system 1200 and provide precise temperature control of a weld. These features allow the welding rod to be directly heated within the first outlet 1215. The first elongate body 1214 defines a first lumen and the second elongate body 1224 defines a second lumen.

In some variations, the first outlet 1215 may comprise a beveled edge facing the heater. For example, the beveled edge may be angled relative to a distal end of the first outlet 1215 up to about 75 degrees, up to about 60 degrees, up to about 45 degrees, up to about 30 degrees, up to about 15 degrees, including all ranges and sub-values in-between (not including zero degrees), thereby allowing the second outlet 1225 to be positioned in closer proximity to the welding rod disposed within the first outlet 1215. The first outlet 1215 may be angled relative to the second outlet 1225 up to about 45 degrees, up to about 30 degrees, and up to 15 degrees, including all ranges and sub-values in-between (not including zero degrees). Accordingly, heat output by the second outlet 1225 may be directed towards the welding rod disposed in the first outlet 1215

In some variations, the heater may comprise a sidewall defining a third outlet 1226 facing the first outlet 1215 of the feeder. The third outlet 1226 may be configured to output heat to the welding rod at a first predetermined temperature and the second outlet 1125 is configured to melt the welding rod at a second predetermined temperature. That is, the welding rod may be heated at the first predetermined temperature and then melted at the second predetermined temperature.

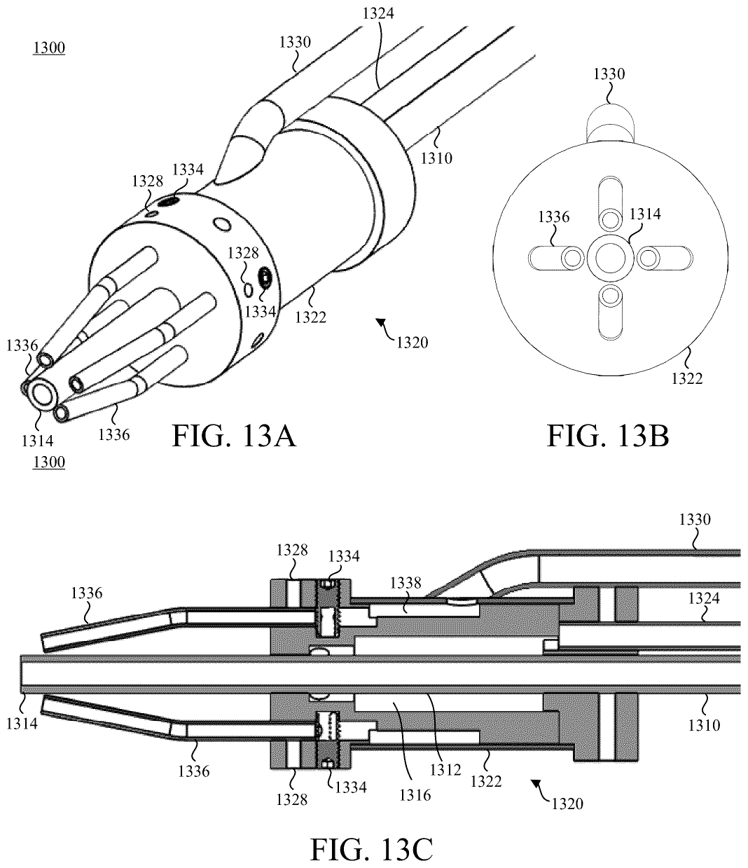

In some variations, a distal end of a heater may include a plurality of outlets to independently control heating around a welding rod output by a feeder to reduce uneven heating and improve one or more of weldment quality, cosmetic appearance, and consistency. For example, a cooling element may be provided to cool a predetermined portion of the feeder proximal to a feeder outlet to reduce clogging of the feeder. FIGS. 13A, 13B, and 13C depict a respective perspective view, front view, and cross-sectional side view of a welding system 1300 including a first elongate body of a feeder 1310, a cooling element 1310, and a second elongate body 1330 of a heater. A welding rod (not shown) may be advanced through the first elongate body and a first outlet 1314. The first elongate body 1310 may define a first lumen include a distal portion 1312 including the first outlet 1314. The cooling element 1320 may comprise an enclosure 1322 coupled to a third elongate body 1324. The enclosure 1322 may define a third lumen 1316 and one or more ports 1328 (e.g., exhaust ports). The distal portion 1312 of the first elongate body 1310 may be disposed in the third lumen 1316 of the cooling element 1320. In some variations, one or more of the first elongate body 1310, second elongate body 1330, and the cooling element 1320 may include one or more temperature sensors (not shown).

In some variations, the heater may comprise the manifold 1332 fluidically coupled between the second elongate body 1330 and the plurality of second outlets 1336. In some variations, the manifold 1332 may be arranged about (e.g., circumferentially around, extending from) the third lumen 1312 of the cooling element 1320. Although any number of second outlets 1336 may be provided, FIGS. 13A-13C show a set of four second outlets 1336 arranged circumferentially and symmetrically about the first outlet 1314 to provide full heating coverage of the welding rod. Each outlet of the plurality of second outlets may be coupled to a corresponding valve 1334. In some variations, the valves 1334 control a flow rate of the heated gas through each of the plurality of second outlets 1336. The valves may be independently controlled based one or more of a set of weld parameters and a temperature signal. In some variations, the valve 1334 may include one or more of a globe valve, pinch valve, needle valve, butterfly valve, plug valve (e.g., modified set screw), ball valve, gate valve, and diaphragm valve. Independent adjustment of a second outlet 1336 may provide greater control over the heating of the welding rod and substrate.

In some variations, the cooling element 1320 may be configured to circulate a non-heated fluid (e.g., gas, ambient air, cooled air) through the third lumen 1316 to cool the distal portion 1312 in order to prevent melting of the welding rod within the distal portion 1312 that may clog the first elongate body 1310 and jam the welding system 1300. While the welding rod may be melted at the first outlet 1314 and easily advanced out of the feeder, a melted welding rod within the distal portion 1312 surrounded by the cooling element 1320 may become stuck within the distal portion 1312 and unable to further advance.

In some variations, the cooling element 1320 may define one or more third outlets 1328 fluidically coupled to the third lumen 1316 to output the non-heated fluid. For example, the non-heated fluid may be output from the third outlets 1328 based on a pressure difference between the third outlet 1328 and a lumen of the third elongate body 1324. In some variations, the cooling element 1320 may comprise a pump (not shown) configured to circulate the non-heated fluid. In this manner, a fluid such as a gas may be circulated to cool the distal portion 1312 of the first elongate body 1310 to reduce melting of the welding rod prior to advancement out of the first outlet 1314.

### C. Cutter

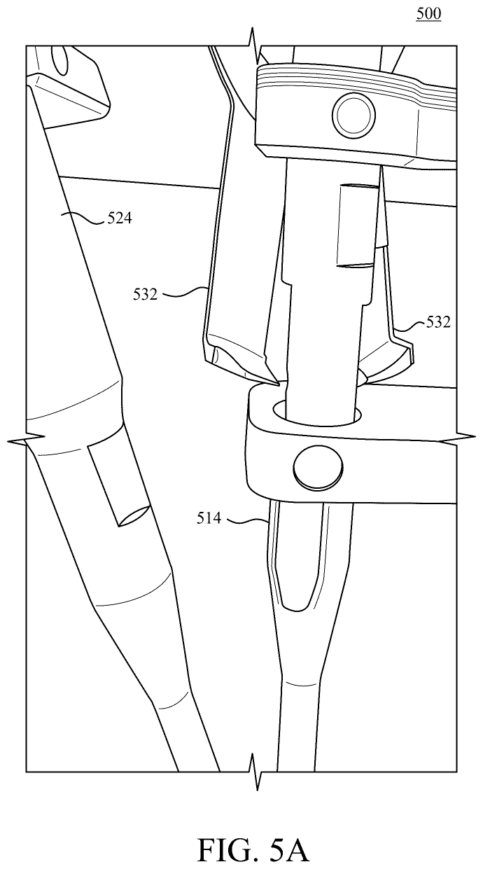

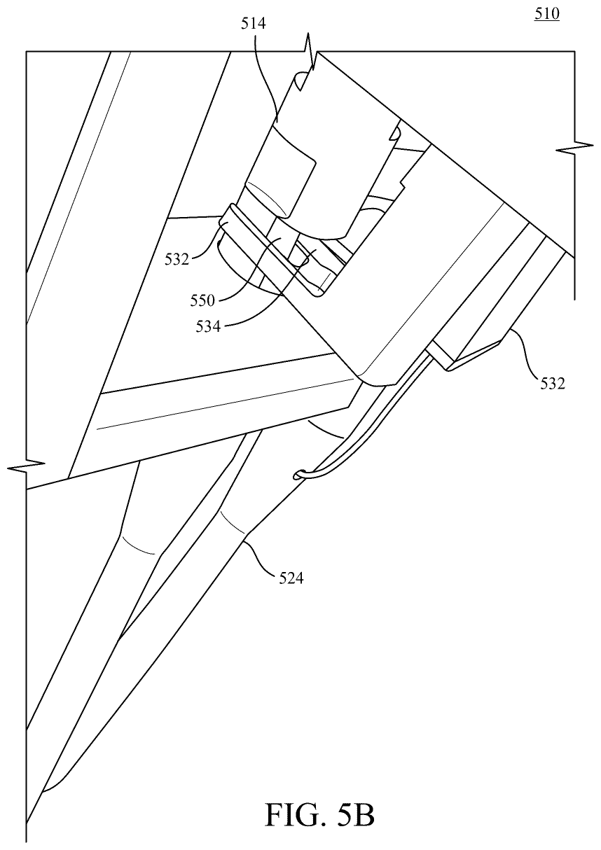

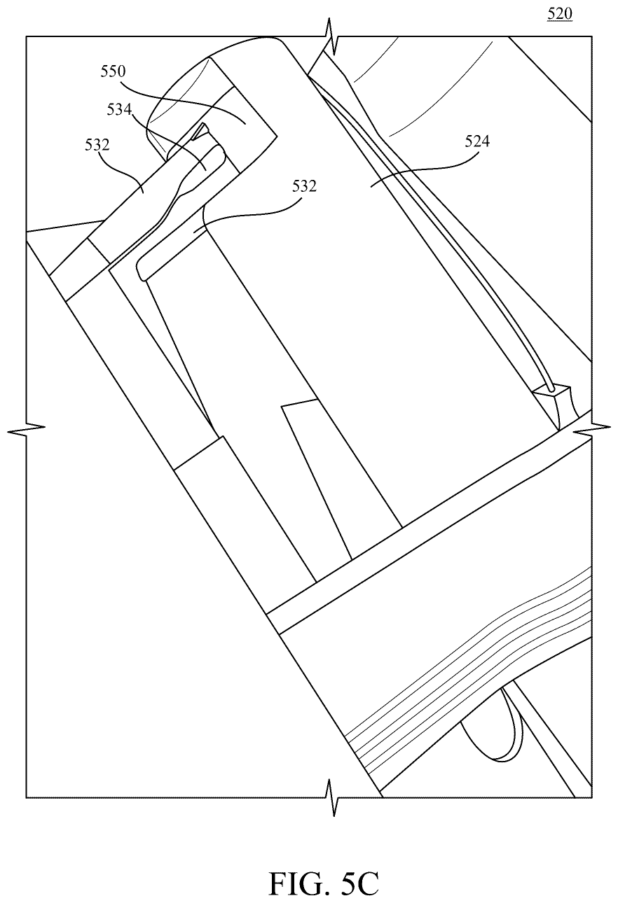

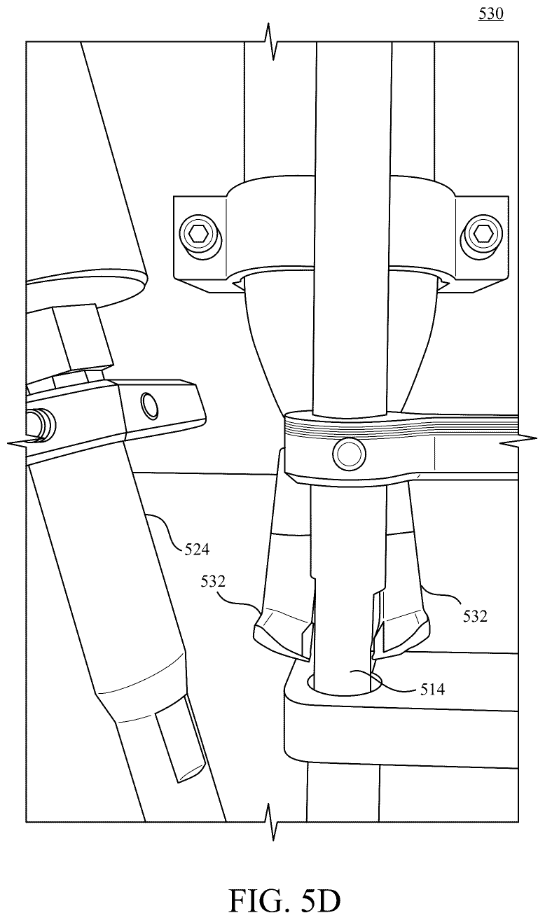

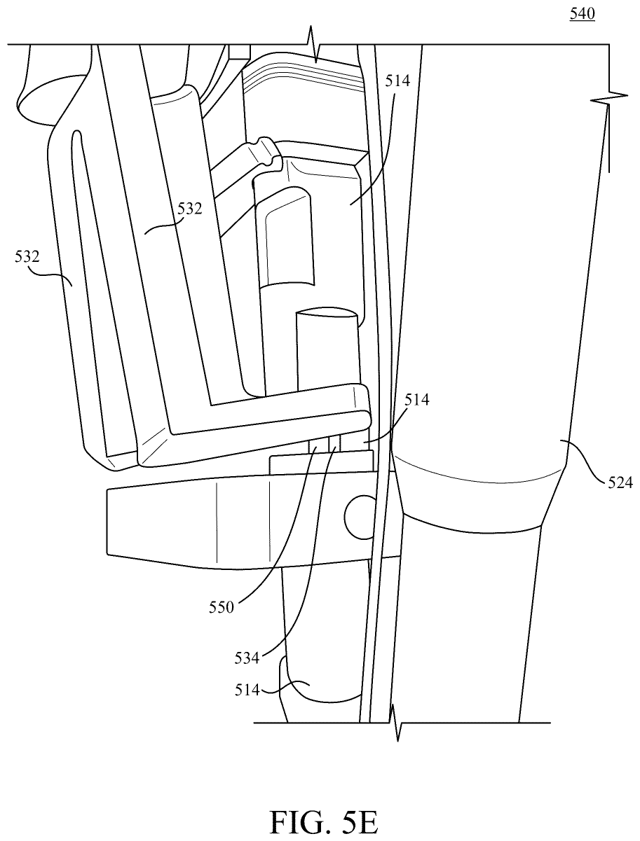

The welding systems described herein may comprise a cutter configured to cut a welding rod disposed within a feeder so as to define an end (e.g., proximal end, distal end) of a weld. FIGS. 5A and 5D depict top views 500, 530 of an exemplary cutter 532 and exemplary feeder 514 of a welding system. The welding system may comprise a first elongate body 514 of a feeder, a second elongate body 524 of a heater, and a cutter 532 (e.g., set of blades). A cutter may comprise at least one cutting element. Cutting elements may include, but are not limited to, one or more of straight blades, serrated blades, circular blades, reciprocal blades, and the like. In some variations, one or more blades may form scissors. FIGS. 5B and 5C depict perspective views 510, 520 of an exemplary cutter 532 and exemplary feeder 514 of a welding system. In some variations, the cutter 532 may be configured to cut an unheated portion of the welding rod 550 disposed within the first elongate body 514. The first elongate body 514 may define an aperture 534 configured to receive a welding rod 550 and cutter 532. The cutter 532 may be configured to cut the welding rod 550 through the aperture 534. In some variations, the cutter 532 may be configured to cut an unheated portion of the welding rod 550 between a proximal end and a distal end of the feeder. In some variations, the cutter may disposed adjacent the feeder such as between a proximal end (e.g., inlet) and a distal end (e.g., outlet) of the feeder. Thus, the cutter 532 may be configured to cut the welding rod disposed within the feeder as opposed to being disposed proximal to the feeder, which would increase an area and/or volume of the welding head. FIG. 5E depicts a side view 540 of an exemplary cutter 532 and exemplary feeder 514 of a welding system. In some variations, the cutter 532 may comprise a pneumatic drive mechanism.

FIGS. 10E and 10F depict respective bottom and perspective views of a cutter 1030 and feeder 1014 of a welding system 1000. The feeder may include a first elongate body 1014 defining a first aperture 1034 configured to receive a welding rod (not shown) and a blade of a cutter 1030. A position sensor 1060 may be configured to determine a presence of a welding rod in the first elongate body 1014. For example, the position sensor 1060 may comprise a proximity sensor such as a photoelectric sensor (e.g., infrared sensor) configured to measure light reflection. In FIGS. 10E and 10F, the proximity sensor 1060 is coupled to the first elongate body 1014.

In some variations, the cutter 1030 may be distal to the set of rollers and may be non-parallel to a first longitudinal axis of the first elongate body 1014. For example, the cutter 1030 is angled relative to the first longitudinal axis up to about 60 degrees, up to about 45 degrees, up to about 30 degrees, up to about 15 degrees, including all ranges and sub-values in-between (not including zero degrees). The cutter 1030 may be configured to cut a welding rod through the aperture 1034 where, for example, a blade of the cutter 1030 may be advanced into the aperture having a welding rod to cut the welding rod. In some variations, the cutter 1030 may be configured to cut an unheated portion of the welding rod between a proximal end and a distal end of the feeder. In some variations, the cutter may disposed adjacent the feeder such as between a proximal end and a distal end of the feeder, which may decrease an overall size/volume of the welding head. Thus, the cutter 1030 may be configured to cut the welding rod disposed within the feeder. In some variations, the cutter 1030 may comprise a pneumatic drive mechanism coupled to the cutting element (e.g., blades or other cutting mechanism). In other variations, however, the cutter may be disposed proximal to the feeder.

In some variations, the cutter 1030 may be configured to cut a welding rod based on a weld parameter. The weld parameter may comprise one or more of weld length, weld geometry, weld material, and weld temperature. In some variations, the position sensor 1060 may be configured to generate a position signal corresponding to a presence of a welding rod, and cutting of the welding rod may be based on the position signal and the set of weld parameters. In some variations, a position sensor 1060 may be coupled to the feeder 1014. For example, the position sensor 1060 may be disposed along the feeder 1014 proximal to the first aperture 1034. In some variations, a processor may be configured to receive a position signal from a position sensor 1060 and a set of weld parameters, and cut the welding rod 550 using the cutter 532 based on the position signal and the set of weld parameters. Accordingly, the welding system may be configured to form weldments of a predetermined length.

### D. Robotic Arm

The welding systems described herein may comprise one or more robotic arms. Generally, one or more welding heads may be releasably (or non-releasably) coupled to a robotic arm where the robotic arm may be configured to moveably suspend a welding head so as to move and hold the welding head at a desired location. With the welding head suspended or held at a desired location by the robotic arm, the system may weld a substrate (e.g., disposed on a platform). The robotic arm may be, for example, an articulated robotic arm, a SCARA robotic arm, and/or a linear robotic arm. The robotic arm may comprise one or more segments coupled together by a joint (e.g., shoulder, elbow, wrist) configured to provide a single degree of freedom. Joints are mechanisms that provide a single translational or rotational degrees of freedom. For example, the robotic arm may have six or more degrees of freedom. The set of Cartesian degrees of freedom may be represented by three translational (position) variables (e.g., surge, heave, sway) and by the three rotational (orientation) variables (e.g., roll, pitch, yaw). In some variations, the robotic arm may have less than six degrees of freedom.

The robotic arm may be configured to move over all areas of a substrate in up to three dimensions. The robotic arm may comprise one or more motors configured to translate and/or rotate the joints and move the robotic arm to a desired location and orientation. The robotic arm may be configured such that a plurality of possible orientations are possible at a desired location. The robotic arm may be mounted to any suitable object, such as a wall, a ceiling, or may be self-standing (e.g., on the ground). Additionally or alternatively, the robotic arm may be configured to be moved manually by an operator. The robotic arm may be configured to carry a payload comprising the robotic arm and welding head. Additionally, the robotic arm may be configured to carry a reel of weld rod.

In some variations, the robotic arm may comprise one or more segments coupled by one or more joints configured to provide a single degree of freedom. In some variations, the robotic arm may comprise one or more motors configured to translate and/or rotate the one or more joints. In some variations, the robotic arm may comprise six or more degrees of freedom. In some variations, the robotic arm may comprise less than six degrees of freedom. In some variations, the robotic arm may comprise one or more of an articulated robotic arm, a SCARA robotic arm, a linear robotic arm, and a robot on a track. In some variations, the robotic arm may be mounted to a base comprising one or more of a wall, a ceiling, a ground, a cart, a turntable, hydraulic lift, pneumatic lift, and a platform. In some variations, the base may be configured to move the robotic arm along at least a first axis.

### E. End Effector Connector

Generally, the end effector connectors described herein may be configured to releasably connect a welding head to a robotic arm. The end effector connectors described herein may be configured to facilitate rapid exchange of a welding head coupled to a robotic arm, thereby enabling welding flexibility and reducing procedure times. For example, an end effector connector 142 may releasably couple a first welding head (e.g., feeder 110, heater 120, cutter 130) to the robotic arm 140 such that a second welding head having a different configuration (e.g., feeder length and/or diameter, nozzle configuration, heating element) for different applications. In some variations, an end effector connector may be coupled to each of the feeder, heater, and the cutter. A robotic arm may be releasably coupled to the end effector connector.

### F. Joint

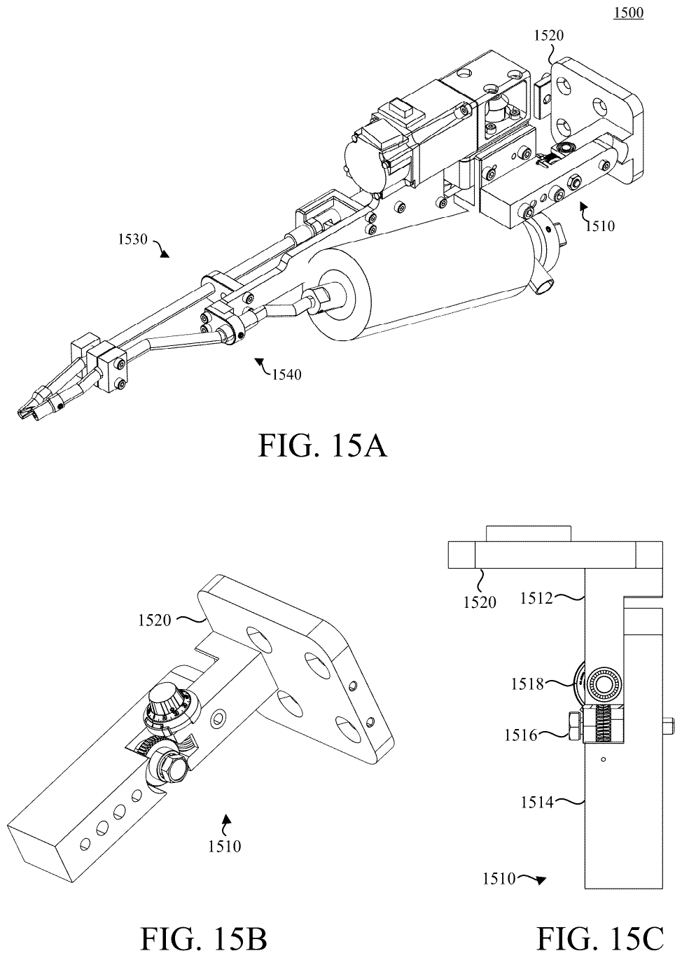

Generally, the joints described herein may be configured to rotate a welding head relative to a robotic arm to provide a predetermined attack angle for a weld in a compact space (e.g., small volume). FIGS. 15A-15C depict respective perspective and top views of a welding system 1500. The welding system 1500 may include a joint 1510, an end effector connector 1520, a feeder 1530, and a heater 1540 similar to those described herein. The joint 1510 may be coupled to the end effector connector 1510 and one or more of the feeder 1530, the heater 1540, and the cutter (not shown) and may be disposed between the end effector connector 1520 and one or more of the feeder 1530, the heater 1540, and the cutter.

The joint 1510 may be configured to rotate the welding head relative to the end effector connector 1520. The end effector connector 1520 may be coupled to a distal end of a robotic arm (not shown). As shown in FIG. 15C, the joint 1510 may comprise a first portion 1512 coupled to a second portion 1514 via a pivot 1516 and an adjustment mechanism 1518 (e.g., knob, slider, button). The second portion 1514 may rotate relative to the first portion 1512. In some variations, the joint 1510 may comprise a gear 1516 (e.g., worm gear, spur gear) and a motor (not shown) configured to drive the gear 1516. The joint 1510 may be configured to rotate up to about 30 degrees, up to about 60 degrees, up to about 75 degrees, up to about 90 degrees relative to the end effector connector 1520, including all ranges and sub-values in-between (not including zero degrees). In some variations, a set of weld parameters may include an attack angle of a weld and the joint may controlled to rotate based on the attack angle. As described herein, an attack angle of about 90 degrees may be optimal for some flat substrate welds while a 45 degree attack angle may be optimal for a right angle substrate weld. In some variations, the welding system may provide a predetermined attack angle through a combination of joint rotation and a predetermined bend at a distal end of the welding head. Although the joint 1510 provides rotation in one degree of freedom, the joint may be configured to rotate in a plurality of degrees of freedom (e.g., two degrees of freedom, three degrees of freedom, four degrees of freedom).

### G. Platform

Generally, a welding system may comprise a platform 146 configured to robotic a substrate disposed thereon. For example, the substrate may be disposed on top of the platform 146. In some variations, a platform 146 may provide a plurality of degrees of freedom to move a substrate on a platform 146 to a desired position and orientation. In some variations, a platform 146 may be configured to be adjustable with a plurality of degrees of freedom to position a substrate relative to the robotic arm 140. For example, the platform 146 may comprise one or more of a yaw drive system, an axial drive system, and a vertical drive system. The yaw drive system may be configured to yaw the platform 146 about a pivot point. The vertical drive system may be configured to control a height and/or pitch of the platform 146. The axial drive system may be configured to translate the platform 146. In some variations, a platform may be configured to receive a substrate for welding. In some variations, the platform may be configured to rotate or pivot the substrate relative to the feeder.

### H. Sensors

The welding systems described herein may optionally comprise one or more sensors (e.g., position sensor 118, temperature sensor 128, optical sensor 150) to facilitate formation of a weldment. A position sensor 118 may be a proximity sensor (e.g., photoelectric senor, infrared light sensor). For example, a welding head may comprise one or more proximity sensors configured to detect a location of the welding held relative to a substrate such that the controller may ensure that the robotic arm and/or the welding head are within a predetermined distance from the substrate (e.g., to prevent collisions). For example, each segment of a robotic arm may comprise an inductive proximity sensor to calculate a distance between the robotic arms. As another example, an infrared, radar, or ultrasonic range finder mounted on the robotic arm may be configured to calculate a distance to the substrate. As yet another example, optical sensors internal and/or external to the robotic arms may be configured to visualize the welding head, operator, platform, substrate, other robotic arms, and the like. A controller may be configured to maintain a predetermined distance between the welding head and a substrate such as a distance of about 1 mm, about 5 mm, about 10 mm, etc. Thus, a controller may limit a range of motion of the robotic arm. In some variations, the sensors may comprise one or more of a force sensor (e.g., Hall sensor, load cell, springs), proximity sensor, optical sensor, motion sensor, accelerometer, gyroscope, laser rangefinder, radar, and LIDAR.

In some variations, a welding system may comprise an optical sensor configured to generate an image signal corresponding to a set of welds. The welding system may further comprise a memory and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics. In some variations, the predicted set of characteristics may comprise one or more of weld size, weld shape, weld geometry, and weld color.

In some variations, a welding grading system may comprise an optical sensor configured to generate an image signal corresponding to a set of welds, a memory, and a processor operatively coupled to the memory and the optical sensor. The processor may be configured to receive the image signal corresponding to the set of welds using the optical sensor, predict a set of characteristics of the set of welds based on the image signal using a machine learning model, and grade the set of welds based on the predicted set of characteristics.

### I. Molder

Generally, a molder 160 of a welding system may be configured to modify a weldment formed on a substrate (e.g., to minimize routing, remove excess weld beading). In some variations, the molder may comprise one or more of an inline welding rod molding flap, and a scraper, sander, combinations thereof, and the like. In some variations, a molder may be coupled to one or more of the feeder, the heater, the cutter, and the robotic arm. The molder may be configured to shape a weld formed on a substrate.

### J. Processor

A welding system 100, as depicted in FIG. 1, may comprise a processor 170 (e.g., controller) and a machine-readable memory 172 in communication with one or more welding heads and/or robotic arms 140. The processor 170 may be connected to the welding head and robotic arm 140 by wired or wireless communication channels. The processor 170 may be located in the same or different room as the substrate and robotic arm 140. The processor 170 may be configured to control one or more components of the welding system 100.

The processor 170 may be implemented consistent with numerous general purpose or special purpose computing systems or configurations. Various exemplary computing systems, environments, and/or configurations that may be suitable for use with the systems and devices disclosed herein may include, but are not limited to software or other components within or embodied on personal computing devices, network appliances, servers or server computing devices such as routing/connectivity components, portable (e.g., hand-held) or laptop devices, multiprocessor systems, microprocessor-based systems, and distributed computing networks.

Examples of portable computing devices include smartphones, personal digital assistants (PDAs), cell phones, tablet PCs, phablets (personal computing devices that are larger than a smartphone, but smaller than a tablet), wearable computers taking the form of smartwatches, portable music devices, and the like, and portable or wearable augmented reality devices that interface with an operator's environment through sensors and may use head-mounted displays for visualization, eye gaze tracking, and user input.

### K. Memory

The processor 170 may incorporate data received from memory 172 and operator input to control one or more robotic arms 140 and welding heads. The memory 172 may further store instructions to cause the processor 170 to execute modules, processes, and/or functions associated with the welding system 100. The processor 170 may be any suitable processing device configured to run and/or execute a set of instructions or code and may comprise one or more data processors, image processors, graphics processing units, physics processing units, digital signal processors, and/or central processing units. The processor 170 may be, for example, a general purpose processor, a Field Programmable Gate Array (FPGA), an Application Specific Integrated Circuit (ASIC), configured to execute application processes and/or other modules, processes, and/or functions associated with the system and/or a network associated therewith. The underlying device technologies may be provided in a variety of component types such as metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, combinations thereof, and the like.

Some variations of memory 172 described herein relate to a computer storage product with a non-transitory computer-readable medium (also may be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as air or a cable). The media and computer code (also may be referred to as code or algorithm) may be those designed and constructed for a specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical discs; solid state storage devices such as a solid state drive (SSD) and a solid state hybrid drive (SSHD); flash memory; carrier wave signal processing modules; and hardware devices that are specially configured to store and execute program code such as Application-Specific Integrated Circuits (ASICs), Programmable Logic Devices (PLDs), Read-Only Memory (ROM), and Random-Access Memory (RAM) devices. Other variations described herein relate to a computer program product, which may include, for example, the instructions and/or computer code disclosed herein.

The systems, devices, and/or methods described herein may be performed by software (executed on hardware), hardware, or a combination thereof. Software modules (executed on hardware) may be expressed in a variety of software languages (e.g., computer code), including C, C++, Java®, Python, Ruby, Visual Basic®, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

### L. Input Device

Generally, an input device 180 of a welding system 100 may serve as a communication interface between an operator and the welding system 100. The input device 180 may be configured to receive input data and output data to one or more of the feeder 110, heater 120, cutter 130, robotic arm 140, platform 146, optical sensor 150, output device 182, and communication device 184. For example, operator control of an input device 180 (e.g., joystick, keyboard, mouse, touch screen) may be processed by processor 170 and memory 172 for input device 180 to output a control signal to one or more robotic arms 140 and welding heads. Sensor data from one or more sensors 118, 128, 150 may be received by input device 180 and output visually, audibly, and/or through haptic feedback by one or more output devices 182.

Some variations of an input device may comprise at least one switch configured to generate a control signal. The control signal may include, for example, a movement signal, a feeding signal, a gas flow signal, a heating signal, a cutting signal, and other signals. In some variations, the input device may comprise a wired and/or wireless transmitter configured to transmit a control signal to a wired and/or wireless receiver of a controller. A movement signal (e.g., for the control of movement, position, and orientation) may control movement in at least four degrees of freedom of motion, and may include yaw and/or pitch rotation. An input device comprising a touch surface may be configured to detect contact and movement on the touch surface using any of a plurality of touch sensitivity technologies including capacitive, resistive, infrared, optical imaging, dispersive signal, acoustic pulse recognition, and surface acoustic wave technologies.

In variations of an input device comprising at least one switch, a switch may comprise, for example, at least one of a button (e.g., hard key, soft key), touch surface, keyboard, analog stick (e.g., joystick), directional pad, mouse, trackball, jog dial, step switch, rocker switch, pointer device (e.g., stylus), motion sensor, image sensor, and microphone. A motion sensor may receive operator movement data from an optical sensor and classify an operator gesture as a control signal. A microphone may receive audio and recognize an operator voice as a control signal. In variations of a system comprising a plurality of input devices, different input devices may generate different types of signals. For example, some input devices (e.g., button, analog stick, directional pad, and keyboard) may be configured to generate a movement signal while other input devices (e.g., step switch, rocker switch) may be configured to transition a component of the welding system (e.g., heater, feeder) between a first configuration and second configuration (e.g., heating element on and off, feeder on and off).

### M. Output Device

An output device 182 of a welding system 100 may be configured to output data corresponding to a welding system, and may comprise one or more of a display device, audio device, and haptic device. A display device may allow an operator to view images of one or more of the welding head, robotic arms, substrates, and weldments. For example, a welding head comprising a visualization device (e.g., camera, optical sensor) may be configured to image a newly-formed weld on the substrate. In some variations, an output device may comprise a display device including at least one of a light emitting diode (LED), liquid crystal display (LCD), electroluminescent display (ELD), plasma display panel (PDP), thin film transistor (TFT), organic light emitting diodes (OLED), electronic paper/e-ink display, laser display, and/or holographic display.

An audio device may audibly output weld data, sensor data, system data, alarms and/or warnings. For example, the audio device may output an audible warning when a weld falls below a predetermined range (e.g., grade) or when a malfunction in a robotic arm is detected. As another example, audio may be output when operator input is overridden by the welding system to prevent potential harm to the operator, welding system, and/or substrate (e.g., collision of robotic arms with each other and/or substrate). In some variations, an audio device may comprise at least one of a speaker, piezoelectric audio device, magnetostrictive speaker, and/or digital speaker. In some variations, an operator may communicate to other users using the audio device and a communication channel. For example, the operator may form an audio communication channel (e.g., VoIP call) with a remote operator and/or observer.

A haptic device may be incorporated into one or more of the input and output devices to provide additional sensory output (e.g., force feedback) to the operator. For example, a haptic device may generate a tactile response (e.g., vibration) to confirm operator input to an input device (e.g., touch surface). Additionally or alternatively, haptic feedback may notify that an operator input is overridden by the welding system to prevent potential harm to the operator, welding system, and/or substrate (e.g., collision of robotic arms with each other and/or substrate).

### N. Communication Device

In some variations, welding systems 100 described herein may communicate with networks and computer systems through a communication device 184. In some variations, the welding system 100 may be in communication with other devices via one or more wired and/or wireless networks. A wireless network may refer to any type of digital network that is not connected by cables of any kind. Examples of wireless communication in a wireless network include, but are not limited to cellular, radio, satellite, and microwave communication. However, a wireless network may connect to a wired network in order to interface with the Internet, other carrier voice and data networks, business networks, and personal networks. A wired network is typically carried over copper twisted pair, coaxial cable and/or fiber optic cables. There are many different types of wired networks including wide area networks (WAN), metropolitan area networks (MAN), local area networks (LAN), Internet area networks (IAN), campus area networks (CAN), global area networks (GAN), like the Internet, and virtual private networks (VPN). Hereinafter, network refers to any combination of wireless, wired, public and private data networks that are typically interconnected through the Internet, to provide a unified networking and information access system.

Cellular communication may encompass technologies such as GSM, PCS, CDMA or GPRS, W-CDMA, EDGE or CDMA2000, LTE, WiMAX, and 5G networking standards. Some wireless network deployments combine networks from multiple cellular networks or use a mix of cellular, Wi-Fi, and satellite communication. In some variations, a communication device may comprise a radiofrequency receiver, transmitter, and/or optical (e.g., infrared) receiver and transmitter. The communication device 184 may communicate by wires and/or wirelessly with one or more of the feeder 110, heater 120, cutter 130, robotic arm 140, platform 146, optical sensor 150, input device 180, output device 182, network, database, server, combinations thereof, and the like.

### O. Enclosure

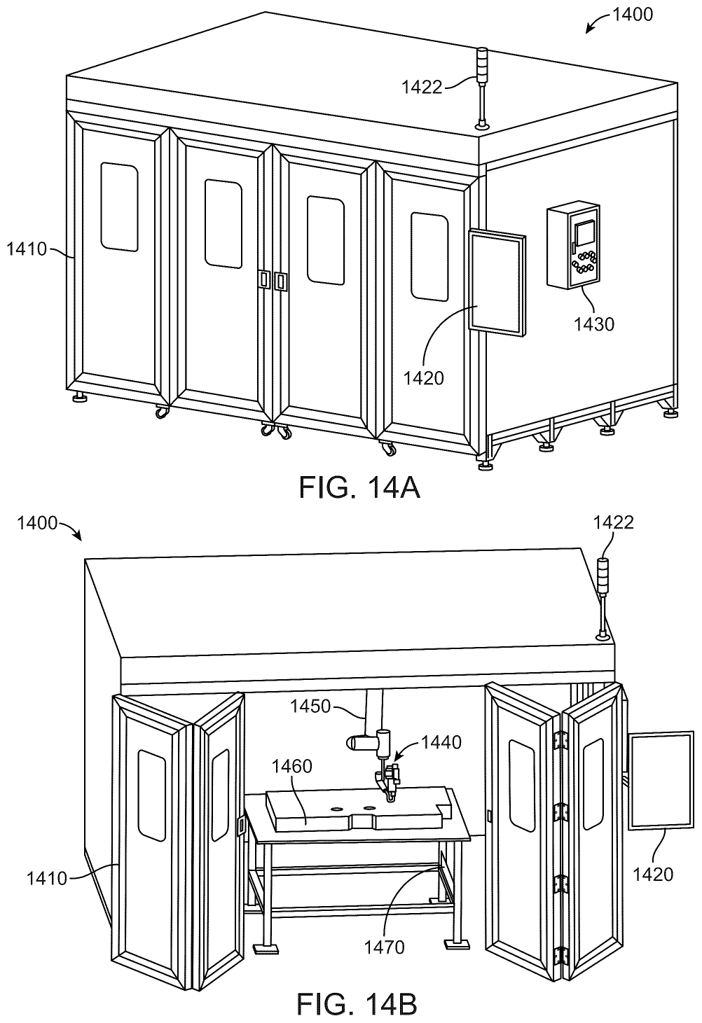

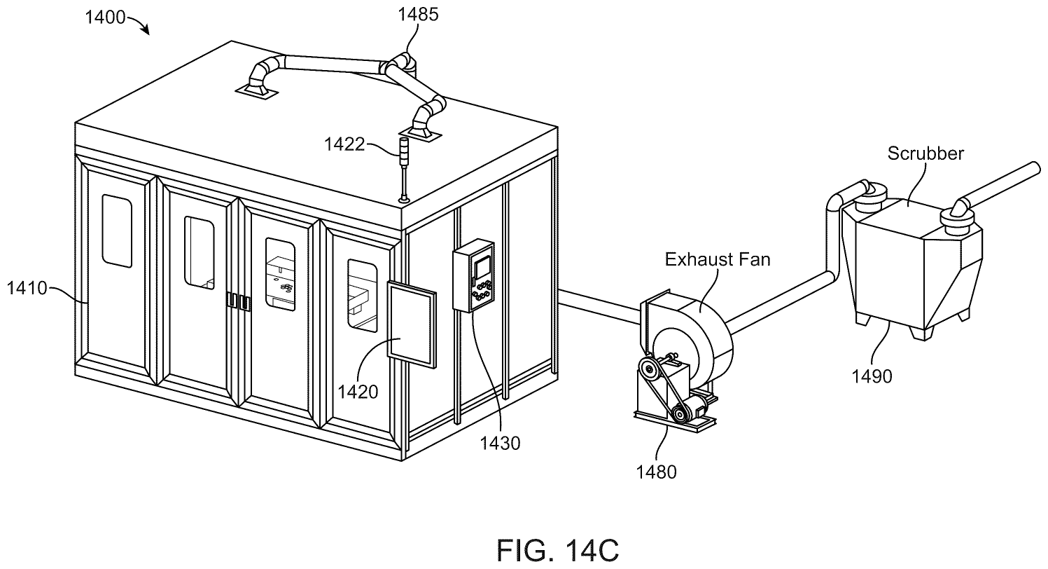

Generally, the enclosures described herein may be configured to seal a welding environment to improve operator safety and health, as well as the welding environment. FIGS. 14A and 14B depict perspective views of a welding system with an enclosure 1400 in respective closed and open configurations. FIG. 14C depicts another perspective view of a welding system with an enclosure 1400 and a vacuum source 1480 and a filter.

Materials used in polymer welding may be hazardous to operators without personal protective equipment. An enclosure configured to contain and/or filter out welding byproducts may improve operator health and air quality, as well as provide a portable workspace that may be modularly constructed and transported. The welding system may comprise an enclosure 1400 having an entrance 1410, and one or more of output devices 1420, 1422 and an input device 1430 disposed on an exterior of the enclosure 1400. The entrance 1410 may be configured to transition between a closed configuration (FIGS. 14A, 14C) and an open configuration (FIG. 14B). The enclosure 1410 may be configured to hermetically seal in gaseous byproducts of a welding process.

In some variations, the enclosure 1400 may encloses a platform 1470 configured to receive a substrate 1460 for welding, a welding device 1440 (e.g., feeder, heater, cutter as described herein), and a robotic arm 1450 coupled to the welding device. For example, the enclosure 1400 may comprise a hermetic seal (e.g., FIGS. 14A, 14C). The robotic arm 1450 is shown in FIG. 14B as coupled to a ceiling of the enclosure 1400, but may alternatively be free-standing, coupled to a wall of the enclosure 1400, coupled to the platform 1470, and the like. As shown in FIG. 14C, a vacuum source 1480 may be coupled to the enclosure 1400 via one or more conduits 1485. The vacuum source 1480 may be configured to apply negative pressure to the enclosure 1400.

In some variations, a filter 1490 (e.g., scrubber) may be configured to remove one or more fluid impurities removed from the enclosure. In some variations, an exterior of the enclosure 1400 may comprise an input device 1480 configured to receive one or more commands from an operator. In some variations, an interior of the enclosure 1400 may comprise an illumination source (not shown) and one or more optical sensors (e.g., video camera) (not shown) configured to generate an image signal corresponding to a set of welds and/or welding system. In some variations, an exterior of the enclosure 1400 may comprise an output device 1420, 1422 configured to output the image signal. For example, a display 1420 may be configured to display a video feed of the welding being performed within the enclosure 1400, and the visual indicator 1422 may indicate a stage of a welding process. For example, an illuminated red light may indicate that welding is in-progress, an illuminated yellow light may indicate that the welding is not in-progress but that the air within the enclosure 1400 has not been completely filtered, and an illuminated green light may indicate that welding is not in-progress and the air is safe to breathe.

In some variations, the filtered fluid may be input (e.g., recycled back) into the enclosure 1410. In some variations, the enclosure 1400 may comprise an air quality sensor configured to measure one more air quality parameters and generate an air quality signal. In some variations, one or more of the vacuum source 1480, filter 1490, and output devices 1420, 1422 may be controlled based on the measured air quality signal.

### II. Methods

Also described here are methods for welding using the welding systems described herein. A robotic welding system having a compact configuration may weld with more efficiency, dexterity, flexibility, and quality than conventional manual and mechanical methods. This may have numerous benefits, such as reducing the cost of welding, increasing throughput, and even improving the cosmetic appearance of welds. Furthermore, the welds may be graded and provided for remedial action (e.g., rework, manual inspection) if necessary. Generally, the methods described here may comprise feeding, heating, and cutting a welding rod all within a welding head coupled to a robotic arm.

### A. Robotic Welding

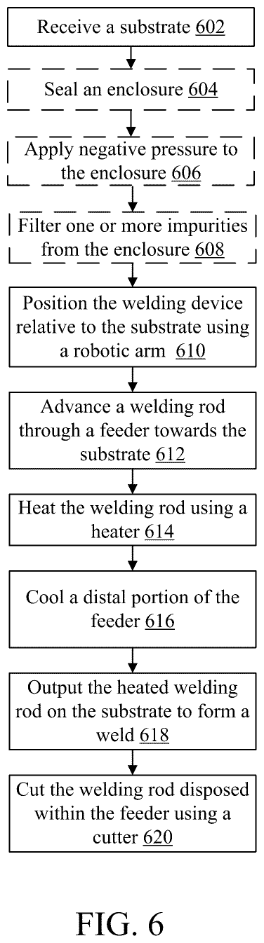

Robotic polymer welding may include forming a weld (e.g., hot gas weld) using a compact welding device coupled to a robotic arm. For example, FIG. 6 is a flowchart that generally describes a method of welding 600 (e.g., hot gas welding) such as forming a polymer (e.g., thermoplastic) weld using any of the systems and devices described herein. The method 600 may include receiving a substrate 602 such as disposing a substrate to be welded on a platform. The platform may be coupled to a robotic arm, the robotic arm may be coupled to a welding device, and the welding device may comprise a feeder, a heater, and a cutter, as described in detail herein. In some variations, a platform may be configured to rotate and/or pivot the substrate relative to the feeder during one or more of the steps of method 600. In some variations, the substate, the robotic arm, the welding device, and the platform may be disposed within an enclosure. The enclosure may be in an open configuration (e.g., entrance of the enclosure is open) when receiving the substrate on the platform.

Optionally, the enclosure may be sealed 604. For example, the enclosure may transition from an open configuration to a closed configuration using an entrance of the enclosure. In some variations, the substrate, the platform, the robotic arm, and the welding device may be hermetically sealed by the enclosure.

Optionally, an interior of the enclosure may be illuminated and an image signal corresponding to the weld and/or any element within the enclosure. The image signal may be output using, for example, a display coupled to an exterior of the enclosure (or any other display). Display of the image signal may facilitate operator review of the welding process from outside the enclosure (e.g., a remote location) away from, for example, high temperatures and exposure to welding byproducts including harmful gases. Optionally, an input device on an exterior of the enclosure may receive one or more commands from an operator to control the welding process.

Optionally, negative pressure may be applied to the enclosure during one or more steps of the method 600. For example, a vacuum source may be fluidically coupled to the enclosure and apply negative pressure. Optionally, one or more impurities may be filtered from the fluid (e.g., gases) removed from the enclosure 608.

The welding device may be positioned relative to the substrate using the robotic arm 610. In some variations, the robotic arm may include one or more motors configured to translate and/or rotate the one or more joints. In some variations, the joint may be configured to rotate up to about 90 degrees relative to an end effector connector coupled to the robotic arm. In some variations, the robotic arm may comprise one or more segments coupled by one or more robotic arm joints, where each robotic arm joint is configured to provide a single degree of freedom. In some variations, the robotic arm may comprise one or more motors configured to translate and/or rotate the one or more robotic arm joints. In some variations, the robotic arm may be mounted to a base configured to move the robotic arm along at least a first axis. positioning the feeder and the heater relative to the substrate using a robotic arm. In some variations, the platform may be configured to rotate or pivot the substrate relative to the welding device. In some variations, a set of weld parameters may include an attack angle corresponding to a geometry of the substrate, and one or more of the joint, the robotic arm, and the platform may be rotated based on the attack angle and/or other weld parameters.

A welding rod may be advanced through the feeder towards the substrate 612. For example, the feeder may include a set of rollers coupled to an actuator, and the set of rollers driven by the actuator may advance the welding rod through the feeder. In some variations, the feeder may include a gear drive coupled between the set of rollers and the actuator. In some variations, the feeder may include a reel coupled to an actuator where the welding rod may be wound around the reel. In some variations, the feeder may include a die configured to modify a diameter of the welding rod. For example, a welding rod having a first diameter may be reduced to a second diameter using a die.

In some variations, the feeder may be configured to feed the welding rod to a substrate at a predetermined rate based on a welding rod signal and a set of weld parameters. In some variations, the predetermined rate (e.g., welding rod feed rate) may include a speed of between about 0.5 mm/sec and about 20 mm/sec. The set of weld parameters may include a presence of the welding rod measured by a position (e.g., proximity) sensor.

The welding rod may be heated at a distal end of the feeder using the heater 614. In some variations, a heated gas may be output from the heater and directed at a distal end of the feeder and the welding rod disposed therein. A flow rate of the heated gas may be adjusted using one or more valves. In some variation, the heater may include one or more valves configured to control a flow rate of the heated gas through each of a plurality of heater outlets. For example, heated gas may be output from a plurality of outlets of the heater where the flow rate of the heated gas from the plurality of outlets is independently adjustable. In some variations, a temperature of one or more of the feeder (e.g., elongate body of the feeder), the welding rod, and the substrate may be measured. One or more parameters of the heater may be selected based on the measured temperature and a set of weld parameters. A heater parameter may include flow rate. For example, one or more parameters of the gas source may comprise a flow rate of up to about 1,500 L/min Atmosphere Normale de Reference (ANR). In some variations, the heater may increase from an ambient temperature to about 380° C. in between about 30 seconds and about 50 seconds, and may decrease from about 380° C. to ambient temperature in between about 60 seconds and 120 seconds. In some variations, a plurality of outlets may heat the welding rod from multiple direction to facilitate a uniform heating.

A distal portion of the feeder may be cooled using a cooling element 616. For example, a non-heated fluid may be circulated through the cooling element using a pump. In particular, a non-heated fluid may be circulated through a lumen of the cooling element to cool a distal portion of the feeder.

The heated welding rod may be output on the substrate to form a weld 618. Optionally, a molder may shape a weld formed on a substrate. A molder may be coupled to one or more of the feeder, the heater, the cutter, and the robotic arm.

The welding rod disposed within the feeder may be cut using a cutter 620. For example, the cutter may cut an unheated portion of the welding rod between a proximal end and the distal end of the feeder. Cutting of the welding rod using the cutter may be based on one or more of a position signal (generated by a position/proximity sensor) and a set of weld parameters.

Optionally, a set of characteristics of the set of welds may be predicted based on the image signal. The set of welds may be graded based on the predicted set of characteristics comprising one or more of size, shape, geometry, and color.

### B. Weld Grading

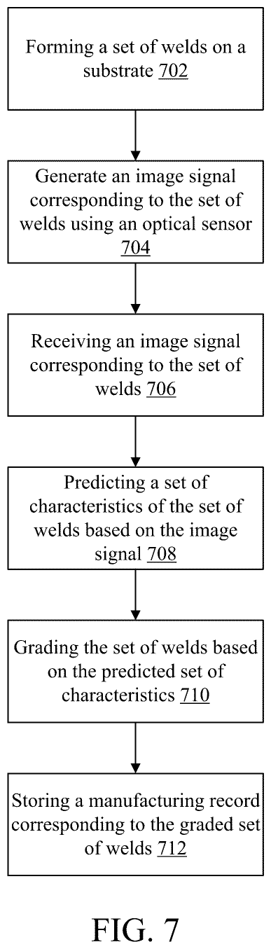

A set of welds formed using the welding systems described herein may be analyzed using a weld grading system. One or more characteristics of a weld such as welding strength and cosmetic appearance may be evaluated and used to generate a manufacturing record (e.g., defect map) that may be useful for weldment repair (e.g., of a cold and/or uneven weld). A defective weld may be rewelded by the welding systems described herein. For example, FIG. 7 is flowchart that generally describes a method of grading a weld 700 such as classifying a polymer weld using any of the systems and devices described herein. The method 700 may include forming a set of welds on a substrate 702. An image signal corresponding to the set of welds may be generated by an optical sensor 704. The image signal corresponding to the set of welds may be received by a processor 706.

A set of characteristics of the set of welds may be predicted based on the image signal using a machine learning model 708. In some variations, the machine learning model may comprise one or more of a deep learning model, convolutional neural network, and combinations thereof.

The set of welds may be graded based on one or more of the predicted set of characteristics and a set of predetermined criteria 710. The predicted set of characteristics may comprise one or more of size, shape, geometry, and color. For example, a yellow weld may indicate a defective weldment. A manufacturing record corresponding to the graded set of welds may be stored in memory 712.

In some variations, the images generated by an optical sensor may be input to a machine-learning model (e.g., weld grade model) that outputs a corresponding weld grade (e.g., welding start, welding finish). In some variations, a weld grade machine-leaning model may be trained using a training set of images corresponding to weld images. For example, the training set may include a plurality of images of welds disposed on a substrate.

In some variations, a notification may optionally be generated based on predetermined criteria. For example, a notification (e.g., audible alert, visual message) may be generated corresponding to a weld grade. The notification may include additional data including but not limited to weld data (e.g., grade), a recommended corrective action, and the like. In some variations, the weld data may comprise one or more of the notifications and may be added as part of a manufacturing record of the substrate. Additionally or alternatively, notifications may be generated when predetermined criteria are not met.

### Examples

As described herein, a set of welds formed by the welding systems described herein on an exemplary basin met or exceeded manual welding standards certified by industry group(s). For example, the set of welds of an exemplary basin passed a first article inspection (FAI). The cosmetic appearance of the set of welds also met or exceeded manual welding standards. The welding cycle time of the welding systems described herein was equal or less than a welding cycle time for manual welding. Additional manual re-welding for the robotic weldment was less than 20% of re-welding required for manual welding. As another example, an exemplary welded tank passed a pressurized water leak test at 10 psi. Other substrates include dip trays, drip pans, housings, panels, aprons, holders, gap basins, doors, enclosures, input stations, pass throughs, main trays, load cups, and the like.

As described herein, a weldment formed by the welding systems described herein on a coupon met or exceeded industry welding standards. For example, a weldment on a standard compliant coupon was tested in compliance with AWS B2.4:2012 and DVS standards. The weldment formed by the systems described herein passed mechanical testing for weldments formed on CP5 and PVC material substrates with a thickness of 3 mm. The weldment formed on the coupon by the systems described herein passed a tensile test in compliance with ASTM D638 standards and passed a bending test in compliance with AWS B2.4:2012 standards.

Although the foregoing variations have, for the purposes of clarity and understanding, been described in some detail by illustration and example, it will be apparent that certain changes and modifications may be practiced, and are intended to fall within the scope of the appended claims. Additionally, it should be understood that the components and characteristics of the systems and devices described herein may be used in any combination. The description of certain elements or characteristics with respect to a specific figure are not intended to be limiting or nor should they be interpreted to suggest that the element cannot be used in combination with any of the other described elements. For all of the variations described herein, the steps of the methods may not be performed sequentially. Some steps are optional such that every step of the methods may not be performed.

We claim:

1. A welding system, comprising:
a feeder configured to receive a welding rod;
a heater coupled to the feeder, the heater configured to control a temperature of the welding rod; and
a cutter coupled to the feeder, the cutter configured to cut the welding rod disposed within the feeder.

2. The welding system of claim 1, wherein the feeder comprises a first elongate body defining a first lumen and a first outlet.

3. The welding system of any of the preceding claims, wherein the first elongate body comprises a first portion and a second portion distal to the first portion, wherein the first portion defines a first longitudinal axis and the second portion is non-parallel to the first longitudinal axis of the first elongate body.

4. The welding system of any of the preceding claims, wherein the second portion is angled up to about 30 degrees relative to the first longitudinal axis of the first elongate body.

5. The welding system of any of the preceding claims, wherein the second portion is angled between about 30 degrees and about 60 degrees relative to the first longitudinal axis of the first elongate body.

6. The welding system of any of the preceding claims, wherein the first portion is proximal to the second portion, and the first portion comprises a first length and the second portion comprises a second length shorter than the first length.

7. The welding system of any of the preceding claims, wherein the first elongate body comprises a sidewall defining an aperture configured to receive the cutter.

8. The welding system of any of the preceding claims, wherein the first portion comprises a sidewall defining an aperture configured to receive the cutter.

9. The welding system of any of the preceding claims, wherein the feeder comprises a die configured to modify a diameter of the welding rod.

10. The welding system of any of the preceding claims, wherein the feeder comprises a set of rollers coupled to an actuator, the set of rollers configured to advance the welding rod through the feeder.

11. The welding system of any of the preceding claims, wherein the feeder comprises a gear drive coupled between the set of rollers and the actuator.

12. The welding system of any of the preceding claims, wherein the feeder comprises a reel coupled to an actuator, the welding rod wound around the reel.

13. The welding system of any of the preceding claims, wherein the feeder is configured to feed the welding rod to a substrate at a predetermined rate based on one or more weld parameters.

14. The welding system of any of the preceding claims, wherein the predetermined rate comprises a speed of between about 0.5 mm/sec and about 20 mm/sec.

15. The welding system of any of the preceding claims, wherein the first outlet defines an aperture at the distal end of the first elongate body and along a sidewall of the first elongate body facing the heater.

16. The welding system of any of the preceding claims, wherein the first outlet comprises a beveled edge facing the heater.

17. The welding system of any of the preceding claims, wherein the beveled edge is angled up to about 75 degrees relative to a distal end of the first outlet.

18. The welding system of any of the preceding claims, wherein the feeder comprises a position sensor configured to generate a position signal corresponding a position of the welding rod.

19. The welding system of any of the preceding claims, comprising a position sensor configured to generate a welding rod signal corresponding to a presence of the welding rod disposed in the first elongate body.

20. The welding system of any of the preceding claims, further comprising:
a memory;
a processor operatively coupled to the memory and the position sensor, the processor configured to:
receive the welding rod signal and a set of weld parameters; and
determine a welding rod feed rate based on the welding rod signal and the set of weld parameters.

21. The welding system of any of the preceding claims, wherein the cutter is configured to cut the welding rod between a proximal end and the distal end of the feeder.

22. The welding system of any of the preceding claims, wherein the cutter is distal to the set of rollers.

23. The welding system of any of the preceding claims, wherein the cutter is configured to cut an unheated portion of the welding rod disposed within the first elongate body.

24. The welding system of any of the preceding claims, wherein the cutter is non-parallel to the first longitudinal axis.

25. The welding system of any of the preceding claims, wherein the cutter is angled up to about 60 degrees relative to the first longitudinal axis.

26. The welding system of any of the preceding claims, wherein the cutter is configured to cut an unheated portion of the welding rod through the aperture.

27. The welding system of any of the preceding claims, wherein the cutter comprises one or more blades.

28. The welding system of any of the preceding claims, wherein the cutter is configured to cut the welding rod based on a weld parameter.

29. The welding system of any of the preceding claims, wherein the weld parameter comprises one or more of length, geometry, material, and temperature.

30. The welding system of any of the preceding claims, further comprising:
a memory;
a processor operatively coupled to the memory and the position sensor, the processor configured to:
receive the position signal and a set of weld parameters; and
cut the welding rod using the cutter based on the position signal and the set of weld parameters.

31. The welding system of any of the preceding claims, wherein the heater comprises a gas source, a second elongate body coupled to the gas source, and a heating element coupled to the second elongate body, the heater configured to output a heated gas at a predetermined flow rate.

32. The welding system of any of the preceding claims, wherein the heating element is distal to the cutter.

33. The welding system of any of the preceding claims, wherein the heating element is parallel to the cutter.

34. The welding system of any of the preceding claims, wherein the second elongate body defines a second lumen and a second outlet.

35. The welding system of any of the preceding claims, wherein the second outlet is proximal to the first outlet.

36. The welding system of any of the preceding claims, wherein the first outlet and the second outlet are non-parallel.

37. The welding system of any of the preceding claims, wherein the first outlet is angled up to about 45 degrees relative to the second outlet.

38. The welding system of any of the preceding claims, wherein the second elongate body comprises a third portion and a fourth portion distal to the third portion, wherein the third portion defines a second longitudinal axis and the fourth portion is non-parallel to the second longitudinal axis of the second elongate body.

39. The welding system of any of the preceding claims, wherein the fourth portion is angled up to about 30 degrees relative to the second longitudinal axis of the second elongate body.

40. The welding system of any of the preceding claims, wherein the fourth portion is angled between about 30 degrees and about 60 degrees relative to the second longitudinal axis of the second elongate body.

41. The welding system of any of the preceding claims, wherein one or more of the heating element and the second elongate body comprises thermal insulation.

42. The welding system of any of the preceding claims, wherein the second elongate body comprises a sidewall defining a third outlet facing the feeder.

43. The welding system of any of the preceding claims, wherein the third outlet is configured to heat the welding rod at a first predetermined temperature and the second outlet is configured to melt the welding rod at a second predetermined temperature.

44. The welding system of any of the preceding claims, wherein the heating element is coupled to the second lumen of the second elongate body.

45. The welding system of any of the preceding claims, wherein the second outlet is positioned within about 2 cm of the first outlet.

46. The welding system of any of the preceding claims, wherein the heating element comprises one or more of ceramic and quartz.

47. The welding system of any of the preceding claims, wherein the gas source comprises pressurized gas.

48. The welding system of any of the preceding claims, wherein the heater comprises one or more temperature sensors configured to generate a temperature signal corresponding to a temperature of one or more of the second elongate body, the welding rod, and a substrate.

49. The welding system of any of the preceding claims, wherein the one or more temperature sensors comprise one or more of a thermocouple, infrared sensor, and laser sensor.

50. The welding system of any of the preceding claims, further comprising:
a memory;
a processor operatively coupled to the memory and the one or more temperature sensors, the processor configured to:
receive the temperature signal and a set of weld parameters; and
select one or more parameters of the gas source and heating element based on the temperature signal and the set of weld parameters.

51. The welding system of any of the preceding claims, wherein the heater defines a plurality of second outlets arranged radially about the first outlet of the feeder.

52. The welding system of any of the preceding claims, wherein the feeder comprises a distal portion including the first outlet, and further comprising a cooling element configured to control a temperature of the distal portion, the cooling element defining a third lumen, wherein the distal portion is disposed in the third lumen.

53. The welding system of any of the preceding claims, wherein the cooling element is configured to circulate a non-heated fluid through the third lumen to cool the distal portion.

54. The welding system of any of the preceding claims, wherein the cooling element defines a third outlet configured to output the non-heated fluid.

55. The welding system of any of the preceding claims, wherein the cooling element comprises a pump configured to circulate the non-heated fluid.

56. The welding system of any of the preceding claims, wherein the non-heated fluid comprises air.

57. The welding system of any of the preceding claims, wherein the heater comprises a manifold fluidically coupled between the second elongate body and the plurality of second outlets.

58. The welding system of any of the preceding claims, wherein the manifold is arranged circumferentially around the third lumen of the cooling element.

59. The welding system of any of the preceding claims, wherein the heater comprises one or more valves configured to control a flow rate of the heated gas through each of the plurality of second outlets.

60. The welding system of any of the preceding claims, comprising an end effector connector coupled to one or more of the feeder, heater, and the cutter;

61. The welding system of any of the preceding claims, further comprising a robotic arm coupled to the end effector connector.

62. The welding system of any of the preceding claims, further comprising a joint coupled to the end effector connector and one or more of the feeder, the heater, and the cutter, wherein the joint is configured to rotate the feeder, the heater, and the cutter relative to the end effector connector.

63. The welding system of any of the preceding claims, wherein the joint is configured to rotate up to about 90 degrees relative to the end effector connector.

64. The welding system of any of the preceding claims, wherein the joint is disposed between the end effector connector and one or more of the feeder, the heater, and the cutter.

65. The welding system of any of the preceding claims, wherein the joint comprises a gear and a motor configured to drive the gear.

66. The welding system of any of the preceding claims, further comprising:
a memory;
a processor operatively coupled to the memory and the joint, the processor configured to:
receive a set of weld parameters comprising an attack angle; and
rotate the joint based on the attack angle.

67. The welding system of any of the preceding claims, comprising a platform configured to receive a substrate for welding.

68. The welding system of any of the preceding claims, wherein the platform is configured to rotate or pivot the substrate relative to the feeder.

69. The welding system of any of the preceding claims, wherein the robotic arm comprises one or more segments coupled by one or more joints configured to provide a single degree of freedom.

70. The welding system of any of the preceding claims, wherein the robotic arm comprises one or more motors configured to translate and/or rotate the one or more joints.

71. The welding system of any of the preceding claims, wherein the robotic arm comprises six or more degrees of freedom.

72. The welding system of any of the preceding claims, wherein the robotic arm comprises less than six degrees of freedom.

73. The welding system of any of the preceding claims, wherein the robotic arm comprises one or more of an articulated robotic arm, a Selective Compliance Articulated Robot Arm (SCARA) robotic arm, and a linear robotic arm.

74. The welding system of any of the preceding claims, wherein the robotic arm is mounted to a base comprising one or more of an enclosure, a wall, a ceiling, a ground, a cart, a turntable, hydraulic lift, pneumatic lift, and a platform.

75. The welding system of any of the preceding claims, wherein the base is configured to move the robotic arm along at least a first axis.

76. The welding system of any of the preceding claims, comprising a molder coupled to one or more of the feeder, the heater, the cutter, and the robotic arm, the molder configured to shape a weld formed on a substrate.

77. The welding system of any of the preceding claims, comprising:
an enclosure comprising a hermetic seal, the enclosure configured to enclose a platform configured to receive a substrate for welding, a feeder configured to receive a welding rod, a heater configured to control a temperature of the welding rod, a cutter configured to cut the welding rod, and a robotic arm coupled to the feeder, the heater and the cutter; and
a vacuum source coupled to the enclosure, the vacuum source configured to apply negative pressure to the enclosure.

78. The welding system of any of the preceding claims, further comprising a filter configured to remove one or more impurities removed from the enclosure.

79. The welding system of any of the preceding claims, wherein an exterior of the enclosure comprises an input device configured to receive one or more commands from an operator.

80. The welding system of any of the preceding claims, wherein an interior of the enclosure comprises an illumination source and one or more optical sensors configured to generate an image signal corresponding to a set of welds.

81. The welding system of any of the preceding claims, wherein an exterior of the enclosure comprises an output device configured to output the image signal.

82. The welding system of any of the preceding claims, wherein the enclosure is configured to hermetically seal the platform, the feeder, the heater, the cutter, and the robotic arm.

83. The welding system of any of the preceding claims, wherein the enclosure comprises one or more entrances.

84. The welding system of any of the preceding claims, further comprising one or more conduits fluidically coupling the enclosure and the vacuum source.

85. The welding system of any of the preceding claims, comprising:
an optical sensor configured to generate an image signal corresponding to a set of welds;
a memory;
a processor operatively coupled to the memory and the optical sensor, the processor configured to:
receive the image signal corresponding to the set of welds using the optical sensor;
predict a set of characteristics of the set of welds based on the image signal using a machine learning model; and
grade the set of welds based on the predicted set of characteristics.

86. The welding system of any of the preceding claims, wherein the predicted set of characteristics comprise one or more of size, shape, geometry, and color.

87. The welding system of any of the preceding claims, wherein the welding rod comprises a thermoplastic and the substrate comprises a polymer.

88. A welding system, comprising:
a feeder defining a first lumen and a first outlet, the feeder configured to advance a welding rod through the first lumen and the first outlet; and
a heater coupled to the feeder, the heater defining a second lumen and a plurality of second outlets arranged radially about the first outlet of the feeder, and the heater configured to output a heated gas to heat the welding rod.

89. The welding system of any of the preceding claims, wherein the feeder comprises a distal portion including the first outlet, and further comprising a cooling element configured to control a temperature of the distal portion, the cooling element defining a third lumen, wherein the distal portion is disposed in the third lumen.

90. The welding system of any of the preceding claims, wherein the cooling element is configured to circulate a non-heated fluid through the third lumen to cool the distal portion.

91. The welding system of any of the preceding claims, wherein the cooling element defines a third outlet configured to output the non-heated fluid.

92. The welding system of any of the preceding claims, wherein the cooling element comprises a pump configured to circulate the non-heated fluid.

93. The welding system of any of the preceding claims, wherein the non-heated fluid comprises air.

94. The welding system of any of the preceding claims, wherein the heater comprises a manifold fluidically coupled between the second elongate body and the plurality of second outlets.

95. The welding system of any of the preceding claims, wherein the manifold is arranged circumferentially around the third lumen of the cooling element.

96. The welding system of any of the preceding claims, wherein the heater comprises one or more valves configured to control a flow rate of the heated gas through each of the plurality of second outlets.

97. A welding system comprising:
an enclosure comprising a hermetic seal, the enclosure comprising:
a platform configured to receive a substrate;
a robotic arm coupled to the platform; and
a welding device coupled to the robotic arm, the welding device configured to form a set of welds on the substrate; and
a vacuum source coupled to the enclosure, the vacuum source configured to apply negative pressure to the enclosure.

98. The welding system of any of the preceding claims, wherein the welding device comprises:
a feeder configured to receive a welding rod;
a heater coupled to the feeder, the heater configured to control a temperature of the welding rod; and
a cutter coupled to the feeder, the cutter configured to cut the welding rod disposed within the feeder.

99. The welding system of any of the preceding claims, further comprising a filter configured to remove one or more impurities removed from the enclosure.

100. The welding system of any of the preceding claims, wherein an exterior of the enclosure comprises an input device configured to receive one or more commands from an operator.

101. The welding system of any of the preceding claims, wherein an interior of the enclosure comprises an illumination source and one or more optical sensors configured to generate an image signal corresponding to the set of welds.

102. The welding system of any of the preceding claims, wherein an exterior of the enclosure comprises an output device configured to output the image signal.

103. The welding system of any of the preceding claims, wherein the enclosure comprises one or more entrances.

104. The welding system of any of the preceding claims, further comprising one or more conduits fluidically coupling the enclosure and the vacuum source.

105. A welding grading system, comprising:
an optical sensor configured to generate an image signal corresponding to a set of welds;
a memory;
a processor operatively coupled to the memory and the optical sensor, the processor configured to:
receive the image signal corresponding to the set of welds using the optical sensor;
predict a set of characteristics of the set of welds based on the image signal using a machine learning model; and
grade the set of welds based on the predicted set of characteristics.

106. The system of any of the preceding claims, wherein the machine learning model comprises one or more of a deep learning model, convolutional neural network (CNN), and combinations thereof.

107. The system of any of the preceding claims, wherein the predicted set of characteristics comprise one or more of size, shape, geometry, and color.

108. The system of any of the preceding claims, wherein grading the set of welds is based on a set of predetermined criteria.

109. A method of welding, comprising:
receiving a substrate on a platform, the platform coupled to a robotic arm, the robotic arm coupled to a welding device, the welding device comprising a feeder, a heater, and a cutter;
positioning the welding device relative to the substrate using the robotic arm;
advancing a welding rod through the feeder towards the substrate;
heating the welding rod at a distal end of the feeder using the heater;
outputting the heated welding rod on the substrate to form a weld; and
cutting the welding rod disposed within the feeder using a cutter.

110. The method of any of the preceding claims, wherein positioning the welding device relative to the substrate is based on a set of weld parameters including an attack angle corresponding to a geometry of the substrate.

111. The method of any of the preceding claims, further comprising:
hermetically sealing the substrate, the platform, the robotic arm, and the welding device using an enclosure; and
applying negative pressure to the enclosure.

112. The method of any of the preceding claims, further comprising transitioning the enclosure from an open configuration to a closed configuration using one or more entrances.

113. The method of any of the preceding claims, further comprising filtering one or more impurities from the enclosure.

114. The method of any of the preceding claims, further comprising determining a presence of the welding rod disposed in the feeder.

115. The method of any of the preceding claims, further comprising determine a welding rod feed rate based on the determined presence of the welding rod and a set of weld parameters.

116. The method of any of the preceding claims, wherein the welding rod is cut between a proximal end and the distal end of the feeder.

117. The method of any of the preceding claims, wherein an unheated portion of the welding rod is cut using the cutter.

118. The method of any of the preceding claims, further comprising:
measuring a temperature of one or more of the feeder, the welding rod, and the substrate; and
selecting one or more parameters of the heater based on the measured temperature and a set of weld parameters.

119. The method of any of the preceding claims, wherein the one or more parameters of the heater comprises a flow rate.

120. The method of any of the preceding claims, further comprising cooling a distal portion of the feeder using a cooling element.

121. The method of any of the preceding claims, wherein cooling the distal portion of the feeder comprises circulating a non-heated fluid through the cooling element using a pump.

122. The method of any of the preceding claims, wherein heating the welding rod at a distal end of the feeder comprises outputting a heated gas from the heater and adjusting a flow rate of the heated gas using one or more valves.

123. The method of any of the preceding claims, wherein heating the welding rod comprises outputting the heated gas from a plurality of outlets of the heater and independently adjusting the flow rate of the heated gas from the plurality of outlets.

124. The method of any of the preceding claims, further comprising:
illuminating an interior of the enclosure;
generating an image signal corresponding to the weld.

125. The method of any of the preceding claims, further comprising outputting the image signal using a display coupled to an exterior of the enclosure.

126. The method of any of the preceding claims, further comprising:
predicting a set of characteristics of the weld based on the image signal; and
grading the weld based on the predicted set of characteristics.

127. A method of grading a weld, comprising:
at one or more processors:
receiving an image signal corresponding to a set of welds and generated by an optical sensor;
predicting a set of characteristics of the set of welds based on the image signal using a machine learning model; and
grading the set of welds based on the predicted set of characteristics.

128. The method of any of the preceding claims, wherein the machine learning model comprises one or more of a deep learning model, convolutional neural network, and combinations thereof.

129. The method of any of the preceding claims, wherein the predicted set of characteristics comprise one or more of size, shape, geometry, and color.

130. The method of any of the preceding claims, wherein grading the set of welds is based on a set of predetermined criteria.
